(19) United States
(12) Patent Application Publication
(10) Pub. No.: US 2026/0318139 A1
(43) Pub. Date: Oct. 15, 2026

(54) HINGE, ADAPTOR, COVER AND ASSEMBLY

(71) Applicant: Polaris IP Pty Ltd, West Gosford, New South Wales (AU)

(72) Inventor: Michael Christopher Stuart, West Gosford, New South Wales (AU)

(21) Appl. No.: 19/107,484

(22) PCT Filed: Aug. 31, 2023
(86) PCT No.: PCT/AU2023/050844

§ 371 Date: Feb. 27, 2025

(30) Foreign Application Priority Data
Aug. 31, 2022 (AU) 2022902500
Feb. 27, 2023 (AU) 2023900502

(51) Int. Cl. E05F 3/20; E05D 3/02; E05D 5/02; E05D 11/00; E05F 1/12

(52) U.S. Cl. CPC E05F 3/20; E05D 3/02; E05D 5/023; E05D 11/0054; E05F 1/1207; E05D 2003/027; E05Y 2201/264; E05Y 2201/41; E05Y 2201/484; E05Y 2600/51; E05Y 2900/40

(57) ABSTRACT

Disclosed is a hinge, an adaptor, a cover, and a hinge assembly. In one aspect, there is provided a hinge including a first leaf assembly hingedly coupled to a second leaf assembly about a hinge axis for movement between an open position and a closed position; the first leaf assembly including a leaf structure having: a first pair of holes for receiving a first pair of fasteners configured to attach the leaf structure to at least one of one or more structures; a second pair of holes for receiving a second pair of fasteners configured to attach the leaf structure to at least one of the one or more structures; and, a third pair of holes for receiving a third pair of fasteners configured to attach the leaf structure to at least one of the one or more structures; wherein, the third pair of holes is flanked on either side by the first pair of holes and the second pair of holes.

### RELATED APPLICATIONS

The present application claims priority from Australian Provisional Application No. 2022902500, filed 31 Aug. 2022, and Australian Provisional Application No. 2023900502, filed 27 Feb. 2023, the contents of which are herein incorporated by reference in their entirety.

### TECHNICAL FIELD

The present invention relates to a hinge, an adaptor, a cover for a hinge, and a hinge assembly.

### BACKGROUND

The Applicant developed a soft-close hinge which is disclosed in PCT/AU2017/050133, the contents of which is herein incorporated by reference in its entirety. This hinge is biased from an open position to a closed position using a torsional spring, and includes one or more dampeners located within an insert to slow the movement of the hinge toward the closed position. The insert locates within a special hole cut into the panel which the hinge was to be fixed thereto. This hinge was particularly advantageous for glass panels, such as pool gates and shower doors, wherein a specialised “mouse ear” profiled hole is provided in an edge of the panel which the insert would be located within. The dampener was effectively located between the faces of the glass panel within the insert, thereby reducing the overall packing size of the hinge. Furthermore, the dampening force was coplanar to the glass meaning that vibrational forces could be reduced when the hinge closed, thereby extending the life of the hinge.

Whilst the hinge disclosed in PCT/AU2017/050133 has been successful in the market, as mentioned above, this type of hinge generally requires the panel to have the specialised “mouse ear” profiled hole provided in the edge of the panel. In a number of instances where non-dampened hinges have been installed, these types of hinges are generally secured to the panel via a pair of holes which allow for a pair of bolts to pass therethrough to clamp the panel. It is not easily possible to replace such a non-dampened hinge with the hinge disclosed in PCT/AU2017/050133 because there is no “mouse-ear” profiled hole to receive the insert. Thus, either the panel needs to be cut with the specialised “mouse ear” profiled hole or a new panel needs to be installed. Both options are less than desirable.

The Applicant also developed a soft close hinge which is disclosed in PCT/AU2021/051056, the contents of which is herein incorporated by reference in its entirety. This hinge is also biased from an open position to a closed position using a torsional spring. The front and rear hinge components are clamped to the panel using fasteners, with one or more dampeners locating behind the panel to which it is attached, and between a hinge axis and said panel face (i.e. coplanar to the panel). As such, this hinge can be installed to panels which have one or more pairs of spaced mounting holes without the need to replace the panel or to arrange for a “mouse ear” profiled hole to be cut into the edge of the panel. Accordingly, the PCT/AU2021/051056 may be used to replace common non-dampened hinges with spaced hole attachment sites in order to retrofit soft-close functionality to panels.

While these hinges have been successful in the market, they are less suitable for use with gates and fences other than panels, such as those involving frames or metal tubular style fences. This may be particularly the case when various holes may already provided in such structures which prevent the hinge be mounted in a secure and reliable manner.

### SUMMARY

It is an object of the present invention to meet this need or to substantially overcome, or at least ameliorate, one or more disadvantages of existing arrangements, or to at least provide the consumer with an alternative choice.

In a first aspect there is provided hinge comprising: a first leaf assembly hingedly coupled to a second leaf assembly about a hinge axis for movement between an open position and a closed position; the first leaf assembly including a leaf structure having: a first pair of holes for receiving a first pair of fasteners configured to attach the leaf structure to at least one of one or more structures; a second pair of holes for receiving a second pair of fasteners configured to attach the leaf structure to at least one of the one or more structures; and a third pair of holes for receiving a third pair of fasteners configured to attach the first structure to at least one of the one or more structures; wherein, the third pair of holes is flanked on either side by the first pair of holes and the second pair of holes.

In certain embodiments, individual holes of the first pair of holes are aligned parallel to the hinge axis.

In certain embodiments, individual holes of the second pair of holes are aligned parallel to the hinge axis.

In certain embodiments, individual holes of the third pair of holes are aligned parallel to the hinge axis.

In certain embodiments, individual holes of the third pair of holes are more closely spaced than individual holes of the first pair of holes.

In certain embodiments, individual holes of the third pair of holes are more closely spaced than individual holes of the second pair of holes.

In certain embodiments, each individual hole of the first pair of holes locates closer to at least one edge periphery of the leaf structure than at least one individual hole of the third pair of holes.

In certain embodiments, each individual hole of the first pair of holes locates closer to two edge peripheries of the leaf structure than at least one individual hole of the third pair of holes.

In certain embodiments, each individual hole of the first pair of holes locates closer to their most proximal corner periphery than either individual hole of the third pair of holes.

In certain embodiments, each individual hole of the second pair of holes locates closer to at least one edge periphery of the leaf structure than at least one individual hole of the third pair of holes.

In certain embodiments, each individual hole of the second pair of holes locates closer to two edge peripheries of the leaf structure than at least one individual hole of the third pair of holes.

In certain embodiments, each individual hole of the second pair of holes locates closer to their most proximal corner periphery than either individual hole of the third pair of holes.

In certain embodiments, one or both holes of the first pair of holes are sized to provide clearance at least partially about a fastener of the first pair of fasteners received by said one or both holes.

In certain embodiments, one or both holes of the second pair of holes are sized to provide clearance at least partially about a fastener of the second pair of fasteners received by said one or both holes.

In certain embodiments, one or both holes of the third pair of holes are sized to provide clearance at least partially about a fastener of the third pair of fasteners received by said one or both holes.

In certain embodiments, one or both of the third pair of holes are adapted to receive a fastener of the third pair of fasteners configured for load-bearing duty independent of the second pair of fasteners.

In certain embodiments, one or both of the third pair of holes are adapted to receive a fastener of the third pair of fasteners configured for load-bearing duty independent of the second pair of fasteners.

In certain embodiments, one or both of the third pair of holes is adapted to receive a fastener of the third pair of fasteners configured as larger than one or both of the first pair of fasteners.

In certain embodiments, one or both of the third pair of holes is adapted to receive a fastener of the third pair of fasteners configured as larger than one or both of the second pair of fasteners.

In certain embodiments, one or both of the third pair of holes are larger than one or both of the first pair of holes.

In certain embodiments, one or both of the third pair of holes are larger than one or both of the second pair of holes.

In certain embodiments, the second leaf assembly includes a mounting structure to mount the second leaf assembly to a mounting structure separate to the hinge.

In certain embodiments, the hinge further includes a spring coupled to the first and second leaf assemblies to bias the first and second leaf assemblies to move from an open position to a closed position.

In certain embodiments, the first and second leaf assemblies include a plurality of knuckles defining a barrel housing the spring, wherein a longitudinal axis of the spring being coaxial with the hinge axis, wherein the hinge further includes: a barrel cap having an inner and outer neck, wherein the outer neck has a first engaging surface, the barrel cap being received within one end of the barrel; and a torsion adjustment structure located within a void defined by the inner neck, the torsion adjustment being coupled to a first end of the spring, the torsion adjustment structure having a second engaging surface which engages with the first engaging surface to restrict rotational movement of the torsion adjustment structure relative to the barrel cap whilst under bias of the spring; wherein a sufficient rotational force applied to the torsion adjustment structure causes the rotational movement of the torsion adjustment structure relative to the barrel cap to increase potential energy stored by the spring.

In certain embodiments, the first and second engaging surfaces have corresponding sawtooth profiles.

In certain embodiments, the spring includes a diametrically extending tail defining a first and second cavity with at least some of the coils of the spring, wherein the torsion adjustment structure includes a pair of protrusions which are received within the respective first and second cavities to enable rotational force applied to the torsion adjustment structure to be transferred to the spring to adjust the potential energy stored by the spring.

In certain embodiments, the spring includes a further diametrically extending tail receivable within an aperture located in a wall of the leaf structure, the wall having protrusions extending therefrom which are receivable within cavities defined by at least some of the coils of the spring and the further diametrically extending tail to couple the spring to the first leaf structure.

In certain embodiments, the hinge further includes a dampener to act against movement of the first and second hinge into the closed position.

In certain embodiments, the dampener has a longitudinal axis which is offset from hinge axis.

In certain embodiments, the longitudinal axis of the dampener does not intersect with the hinge axis during any part of the movement between the open and closed positions.

In certain embodiments, the longitudinal axis is located between the hinge axis and a mounting face of the first leaf assembly configured to bear against at least one of the one or more structures to which the first leaf assembly attaches.

In certain embodiments, the hinge includes a plurality of dampeners located within a dampener housing mounted to the first leaf assembly with ends of said plurality of dampeners projecting from the housing when the hinge is in the open position, such that as the hinge is moved into the closed position, the projecting dampener ends interact with a striking surface associated with the second leaf assembly.

In certain embodiments, the hinge further includes a cover member covering the protruding ends of the dampeners, the cover member configured for co-movement with the dampeners.

In certain embodiments, the cover member is limited to linear reciprocal movement along the dampener longitudinal axis relative the dampener housing.

In certain embodiments, the second leaf assembly includes a further leaf structure having: a first pair of holes for receiving a first pair of fasteners configured to attach the further leaf structure to at least one of one or more further structures; a second pair of holes for receiving a second pair of fasteners configured to attach the further leaf structure to at least one of the one or more further structures; and a third pair of holes for receiving a third pair of fasteners configured to attach the further leaf structure to at least one of the one or more further structures; wherein,
the third pair of holes is flanked on either side by the first pair of holes and the second pair of holes.

In certain embodiments, the first pair of holes, the second pair of holes and the third pair of holes of the further leaf structure have equivalent properties to the first pair of holes, the second pair of holes and the third pair of hole of the leaf structure according to above embodiments.

In a second aspect there is provided a hinge comprising: a first leaf assembly hingedly coupled to a second leaf assembly about a hinge axis for movement between an open position and a closed position, wherein a bias structure biases movement into the closed position, and a dampening assembly configured to slow movement into the closed position, the dampening assembly including a dampener housing and a cover member cooperating to contain one or more dampeners, the cover member configured for reciprocal movement relative the housing thereby transferring a reciprocal force to the one or more dampeners.

In certain embodiments, the hinge axis is offset from a dampener axis.

In certain embodiments, the dampener axis does not intersect with the hinge axis during any part of the movement between the open and closed positions.

In certain embodiments, the hinge further comprises a striking structure locating on an opposite leaf assembly to the dampener housing, a striking surface of the striking structure contacting with the cover member during movement of the hinge into the closed position.

In a third aspect there is provided an adapter for mounting the hinge according to the first or second aspect and/or embodiments thereof, the adaptor having a channel portion for receiving a frame member of a frame structure, and a screw block adapted to receive at least one of the first, second and/or third pairs of fasteners.

In a fourth aspect there is provided an adaptor for connecting a hinge to a frame, the adaptor including a channel for receiving the frame, and a screw block configured to provide an extension surface providing an additional site for connection with the hinge.

In a fifth aspect there is provided a cover for a leaf structure of a hinge, the cover including: a main cover body having a lip extending partially about a periphery thereof, the lip defining a mouth for receiving the leaf structure of the hinge; and a first clip and second clip projecting outwardly from opposing sides of the mouth, the first and second clip being resilient and inwardly angled toward each other to resiliently engage the leaf structure when received within the mouth.

In certain embodiments, the first and second clip are inwardly angled by an angular offset relative to a hinge axis of the hinge, wherein the angular offset is between approximately 92° and 100° relative to the hinge axis.

In certain embodiments, the angular offset is between approximately 93° and 97° relative to the hinge axis.

In certain embodiments, the angular offset is between approximately 95° and 96° relative to the hinge axis.

In certain embodiments, the first clip and second clip include a first and second ridge, wherein the first and second ridges extend orthogonally to each other along a periphery of the respective clip, wherein each ridge resiliently engages over an edge of the leaf structure.

In certain embodiments, the cover is made of plastic.

In certain embodiments, the cover is made of metal.

In certain embodiments, the metal is stainless steel.

In certain embodiments, the mouth includes a recessed midsection to accommodate a portion of a barrel of the hinge.

In certain embodiments, the mouth includes a tongued midsection to protrude between a barrel of the hinge and the leaf structure.

In certain embodiments, the cover is configured to cover at least the leaf structure of the hinge configured according to the first aspect and/or embodiments.

In a sixth aspect there is provided an adaptor for connecting a hinge to a post coupled to a chain wire fence, wherein the adaptor includes a body having a coupling surface including a first pair of coupling holes for coupling the hinge to the adaptor via a first and second pair of fasteners; and a mounting surface having a plurality of mounting protrusions locatable, in a mounted position, between one or more wires wrapped about the post, and one or more pairs of mounting holes for mounting the adaptor to the post, wherein a third pair of fasteners mount the hinge and adapter to the post via the one or more pairs of mounting holes.

In certain embodiments, the post has a curved profile, wherein the mounting surface has a substantially curved profile corresponding to a segment of the curved profile of the post.

In certain embodiments, each mounting protrusion has a mounting face having a curved profile that corresponds to a further segment of the curved profile of the post such that each mounting face sits substantially flush against the post, wherein the further segment is smaller than the segment.

In certain embodiments, a majority of the mounting protrusions have a cross-sectional profile of an equilateral quadrilateral.

In certain embodiments, the equilateral quadrilateral is a rhombus.

In certain embodiments, the one or more wires are helically wrapped about the post, wherein a portion of the one or more wires covered by the adaptor in the mounting position are located between neighbouring mounting protrusions of the adaptor to allow the mounting faces of the mounting protrusions to sit substantially flush against the post.

In certain embodiments, the one or more wires are a plurality of tie-wires tied around the post, wherein a portion of one of the tie-wires that is covered by the adaptor is located within a clearance between an upper portion of the mounting protrusions and a lower portion of the mounting protrusions of the adaptor to allow the mounting faces of the mounting protrusions to sit substantially flush against the post.

In certain embodiments, the one or more pairs of mounting holes include a first pair of mounting holes and a second pair of mounting holes, the first and second mounting extending from the coupling surface through to the mounting surface, wherein the second pair of mounting holes extend orthogonally to the first pair of mounting holes, wherein the first pair of mounting holes are configured to receive the third pair of fasteners to fasten the hinge coupled to the adaptor to the post, wherein the second pair of mounting holes are configured to receive a fourth pair of fasteners to fasten the hinge coupled to the adaptor to the post.

In certain embodiments, the further pair of mounting holes protrude through at least some of the plurality of mounting protrusions.

In certain embodiments, the first and second pair of coupling holes are threaded holes.

In certain embodiments, at least one of the first and second pair of coupling holes are blind threaded holes.

In certain embodiments, the post is a steel pipe, wherein the adaptor is configured to mount to the steel pipe having a pipe size of: 25 Nominal Bore, 32 Nominal Bore, or 40 Nominal Bore.

In certain embodiments, the chain wire fence comprises of a diamond wire mesh, wherein some of the diamond wire mesh is located within channels defined between neighbouring mounting protrusions in the mounted position.

In a seventh aspect there is provided a hinge assembly comprising: a hinge configured according to the first or second aspect and/or embodiments thereof; and a cover configured according to the fifth aspect and/or embodiments thereof, wherein the cover is engaged with the leaf structure of the hinge.

In an eighth aspect there is provided a hinge assembly comprising: a hinge configured according to embodiments of the first aspect which include the further lead structure; a cover configured according to the fifth aspect and/or embodiments thereof, wherein the cover is engaged with the leaf structure of the hinge; and a further cover configured according to the fifth aspect and/or embodiments thereof, wherein the cover is engaged with the further leaf structure of the hinge.

In a ninth aspect there is provided a hinge assembly comprising: a hinge configured according to the first aspect and/or embodiments thereof; and an adaptor configured according to the fourth aspect, wherein the hinge is connected to the adaptor.

In a tenth aspect there is provided a hinge assembly comprising: a hinge configured according to the first aspect and/or embodiments thereof; and an adaptor configured according to the sixth aspect and/or embodiments thereof, wherein the adaptor is coupled to the hinge.

In certain embodiments, the hinge assembly further includes a cover configured according to the fifth aspect and/or embodiments thereof, wherein the cover is engaged with the leaf structure of the hinge.

In an eleventh aspect there is provided a hinge assembly comprising: a hinge configured according to the first aspect and/or embodiments thereof that include a further leaf structure; an adaptor configured according to the sixth aspect and/or embodiments thereof, wherein the adaptor is coupled to the hinge; a cover configured according to the fifth aspect and/or embodiments thereof, wherein the cover is engaged with the leaf structure of the hinge; and a further cover configured according to the fifth aspect and/or embodiments thereof, wherein the further cover is engaged with the further leaf structure of the hinge.

Other aspects and embodiments will be appreciated throughout the detailed description of one or more preferred embodiments.

### BRIEF DESCRIPTION OF THE DRAWINGS

Example embodiments should become apparent from the following description, which is given by way of example only, of at least one preferred but non-limiting embodiment, described in connection with the accompanying figures.

FIG. 1 is an exploded parts diagram of an embodiment of a hinge according to the present invention.

FIG. 2 is an exploded parts diagram of the FIG. 1 hinge viewed at an alternate angle.

FIG. 3 is a plan view of the FIG. 1 hinge.

FIG. 4 is a sectional view of the FIG. 3 hinge taken along line A-A.

FIG. 5 is a section view of the FIG. 3 hinge along line B-B.

FIG. 6 is a section view of the FIG. 3 hinge along line C-C.

FIG. 7 is an isomeric sectional with torsion adjustment structure intact.

FIG. 8 is an isomeric sectional with torsion adjustment structure also shown in section.

FIG. 9 is a view of the hinge according to the present invention.

FIG. 10 is an alternative view of the FIG. 9 hinge.

FIG. 11 is an alternative view of the FIG. 9 hinge.

FIG. 12 is an alternative view of the FIG. 9 hinge.

FIG. 13 is an alternative view of the FIG. 9 hinge.

FIG. 14 is an alternative view of the FIG. 9 hinge.

FIG. 15 is an alternative view of the FIG. 9 hinge.

FIG. 16 is an alternative view of the FIG. 9 hinge.

FIG. 17 is an alternative view of the FIG. 9 hinge.

FIG. 18 is an alternative view of the FIG. 9 hinge.

FIG. 19 is a view of the hinge according to the present invention absent the front cover and fasteners.

FIG. 20 is an alternative view of the FIG. 19 hinge.

FIG. 21 is an alternative view of the FIG. 19 hinge.

FIG. 22 is an alternative view of the FIG. 19 hinge.

FIG. 23 is an alternative view of the FIG. 19 hinge.

FIG. 24 is an alternative view of the FIG. 19 hinge.

FIG. 25 is an alternative view of the FIG. 19 hinge.

FIG. 26 is an alternative view of the FIG. 19 hinge.

FIG. 27 is an alternative view of the FIG. 19 hinge.

FIG. 28 is an alternative view of the FIG. 19 hinge.

FIG. 29 shows a hinge with a dampener assembly according to the present invention.

FIG. 30 shows an alternative hinge with a dampener assembly according to the present invention.

FIG. 31 shows an adaptor for connecting a hinge to a narrow structure, provided in the form of a panel, according to the present invention.

FIG. 32 shows an isometric view of the adaptor of FIG. 31 in isolation.

FIG. 33 shows a front view of an example of a first cover to attach to a hinge.

FIG. 34 shows a rear view of the first cover of FIG. 33.

FIG. 35 shows a top and right perspective view of the first cover of FIG. 33.

FIG. 36 shows a bottom and right perspective view of the first cover of FIG. 33.

FIG. 37 shows a front view of an example of a second cover to attach to a hinge.

FIG. 38 shows a rear view of the second cover of FIG. 37.

FIG. 39 shows a top and left perspective view of the second cover of FIG. 37.

FIG. 40 shows a bottom and left perspective view of the second cover of FIG. 37.

FIG. 41 is a schematic view of an example of a hinge assembly including the hinge of FIG. 1 to 30 and coupled to examples of alternat adaptors for attaching the hinge assembly to a post.

FIG. 42 is a further schematic view of the hinge assembly of FIG. 41.

FIG. 43 is a top view of the hinge assembly of FIG. 41.

FIG. 44A is an isometric view of the hinge assembly of FIG. 41 attached to a pair of posts with wire helically wrapped thereabout.

FIG. 44B is a top view of the hinge assembly connected to the pair of posts of FIG. 44A.

FIG. 45A is an isometric view of the hinge assembly of FIG. 41 attached to a pair of posts with a plurality of tie-back wires wrapped thereabout.

FIG. 45B is a top view of the hinge assembly connected to the pair of posts of FIG. 45A.

FIG. 46A is an isometric view of the hinge assembly of FIG. 41 attached to a pair of posts with no wire wrapped thereabout.

FIG. 46B is a top view of the hinge assembly connected to the pair of posts of FIG. 46A.

FIG. 47A is a schematic front view of a first example of an adaptor for attaching a hinge to a post.

FIG. 47B is a schematic rear view of the adaptor of FIG. 47A.

FIG. 48A is a schematic front view of a second example of an adaptor for attaching a hinge to a post.

FIG. 48B is a schematic rear view of the adaptor of FIG. 48A.

FIG. 49A is a schematic front view of a first example of an adaptor for attaching a hinge to a post.

FIG. 49B is a schematic rear view of the adaptor of FIG. 49A.

FIG. 50 is a schematic view of an alternate example of a torsion adjustment structure.

FIG. 51 is a rotated schematic view of the torsion adjustment structure of FIG. 50.

FIG. 52 is a cross-sectional view of the hinge of FIG. 29 incorporating the torsion adjustment structure of FIG. 50.

### DETAILED DESCRIPTION OF THE EMBODIMENTS

The following modes, given by way of example only, are described in order to provide a more precise understanding of the subject matter of a preferred embodiment or embodiments. In the figures, incorporated to illustrate features of an example embodiments, like reference numerals are used to identify like parts throughout the figures.

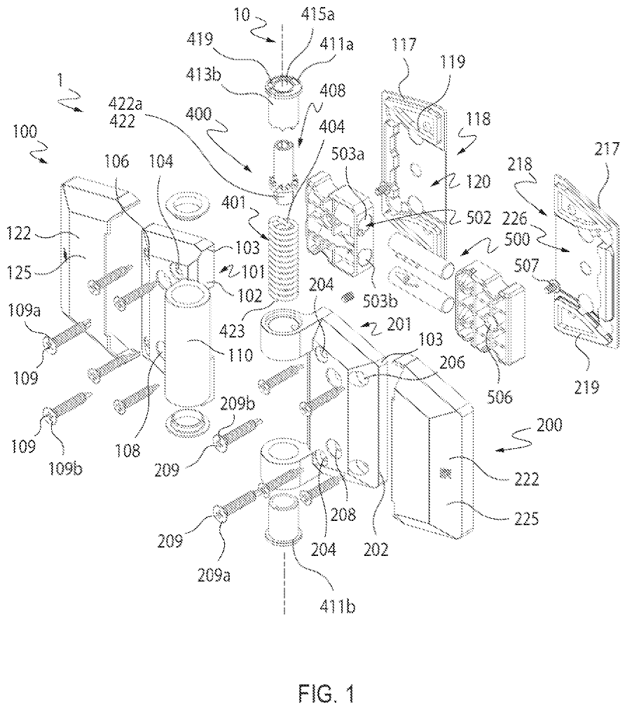

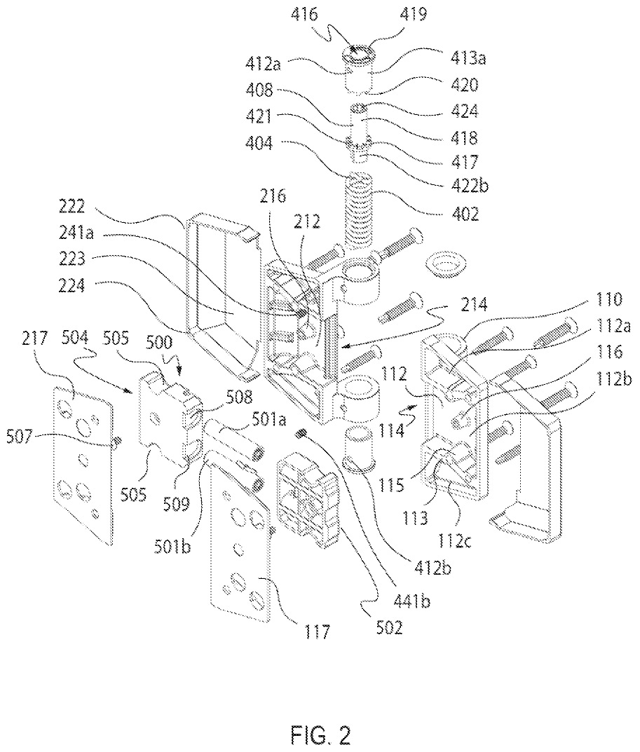

With reference to FIGS. 1 and 2, shown is an example embodiment of a hinge 1 according to the present invention. The hinge 1 of this example embodiment is a face mounted hinge with soft-close functionality to dampen a closing force exerted on the hinge 1.

The hinge includes a first leaf assembly 100 hingedly coupled to a second leaf assembly 200 about a hinge axis 10. The first leaf assembly 100 and second leaf assembly 200 are configured for movement about the hinge axis 10 at between an open position and a closed position. In alternative embodiments to that depicted, the extent of travel afforded between the first leaf assembly 100 and a second leaf assembly 200 may extend beyond the generally open and closed positions. The hinge 1 further includes a dampening assembly 500 comprising one or more dampeners 501a, 501b. In one form, the none or more dampeners may be one or more linear dampeners. As discussed below, the hinge can operate with a single dampener, thus the reference number 501 will be used to refer to a single dampener but similarly applies to a multi-dampener arrangement 501a, 501b. The hinge 1 also includes a bias structure 400, such as a spring 401, which may be configured to bias the hinge 1 into the closed position.

The first leaf assembly 100 includes a leaf structure 101 for attachment to a portion of one or more structures, for example a first panel 1001 (not shown). For the purposes of clarity as will become clear throughout the various examples, the leaf structure 101 will herein be referred to as the first leaf structure. The first leaf structure 101 has a first pair of holes 104 each of which 104a, 104b are configured to receive one of a first pair of fasteners 105 for attachment of the first leaf structure 101 to the pane 1001. In the depicted embodiment, the first pair of fasteners 105 are self-tapping screws that can embed within a panel without pre-formed holes or threads, however, other fasteners as known to the art may be used. The pair of first holes 104 are vertically aligned. The first pair of holes 104 are aligned parallel with the hinge axis 10 and are arranged proximal to an inner edge periphery 102a of the first leaf structure 101 nearest the spring 401. Each 104a, 104b of the first pair of holes 104 are spaced from each other such that each 104a, 104b locates proximal to an adjacent corner periphery 103 of the first leaf structure 101. The adjacent corner peripheries 103 are the inner upper corner periphery 103a and the lower inner corner periphery 103b. One of the first pair of holes 104a locates proximal to an upper edge periphery 102c, while the other of the first pair of holes 104b located proximal to a lower edge periphery 102d of the first leaf structure 101. Each of the holes 104a, 104b of the first pair of holes 104 may be equally spaced from a vertical mid-point of the first leaf structure 101 or near to said mid-point. Each of the holes 104a, 104b of the first pair of holes 104 may be equally spaced about a horizontal axis of symmetry of the first leaf structure 101.

The first leaf structure 101 also has a second pair of holes 106, each of which 106a, 106b are configured to receive one 107a, 107b of a second pair of fasteners 107 for attachment of the first leaf structure 101 to the panel 1001. In the depicted embodiment, the second pair of fasteners 107 are self-tapping screws that can embed within a panel without pre-formed holes or threads, though other fasteners may be used. The pair of second holes 106 are vertically aligned. The second pair of holes 106 are aligned parallel with the hinge axis 10 and are arranged proximal to an outer edge periphery 102b of the first leaf structure 101 furthest the spring 501. Each 106a, 106b of the second pair of holes 106 are spaced from each other such that each 106a, 106b locates proximal to an adjacent corner periphery 103 of the first leaf structure 101. The adjacent corner peripheries 103 are the upper outer corner periphery 103c and the lower outer corner periphery 103d. One of the second pair of holes 106a locates proximal to an upper edge periphery 102c, while the other of the second pair of holes 106b located proximal to a lower edge periphery 102d of the first leaf structure 101. Each of the holes 106a, 106b of the second pair of holes 106 may be equally spaced from a vertical mid-point of the first leaf structure 101 or near to a mid-point. Each of the holes 106a, 106b of the second pair of holes 106 may be equally spaced about a horizontal axis of symmetry of the first leaf structure 101.

The first leaf structure 101 also has a third pair of holes 108, each of which are configured to receive one 109a, 109b of a third pair of fasteners 109 for attachment of the first leaf structure 101 to the panel 1001. In the depicted embodiment, the third pair of fasteners 109 are self-tapping screws that can embed within a panel without pre-formed holes or threads, though other fasteners may be used as appropriate. The pair of third holes 108 are vertically aligned. The first pair of holes 108 are aligned parallel with the hinge axis 10 and are arranged proximal to an outer edge periphery 102b of the first leaf structure 101 nearest the spring 501. The third pair of holes 108 may locate within a footprint defined by the holes of the first 104 and second 106 pair of holes. The third pair of holes 108 are flanked on one side by the first pair of holes 104 and the other side by the second pair of holes 106. The third pair of holes 108 may be centrally located along the horizontal extent (i.e. a horizontal mid-point of the first leaf structure(s), or near centrally located. As depicted, the third pair of holes 108 may be more closely spaced than the first pair of holes 104 or second pair of holes 106, though other arrangements are possible. Each of the holes 108a, 108b of the third pair of holes 108 may be equally spaced from a vertical mid-point of the first leaf structure 101 or near to a mid-point. Each of the holes 108a, 108b of the third pair of holes 108 may be equally spaced about a horizontal axis of symmetry of the first leaf structure.

Any or all of the individual holes 104a, 104b, 106a, 106b, 108a, 108b of the first 104, second 106 or third 108 pair of holes may be sized to offer clearance from a respective fastener when received therein. In the embodiment depicted by FIGS. 1 and 2, each hole 104a, 104b of the first pair of holes 104 is sized to provide clearance between the fastener 105a, 105b of the first pair 105 received by that hole. Otherwise stated, the hole 104a, 104b is sized to allow a certain degree of play between the fastener 105a, 105b in that hole. By this arrangement with the first leaf structure 101 in place against the panel 1001, each hole 104a, 104b is sized to allow some slight variance in where the fastener 105a, 105b is applied. Specifically, instead of the hole 104a, 104b being matched with tight tolerance to the size of the fastener 105a, 105b such that the fastener 105a, 105b must be positioned dead-centre or substantially dead centre in the hole 104a, 104b, the fastener 105a, 105b may be applied slightly off-center. This allows the installer of the hinge 1 some degree of selection of where the fasteners 105a, 105b are positioned within its respective hole 104a, 104b of the first leaf structure 101 for any given position of the first leaf structure 101 relative the panel 1001 to which it attaches.

Similarly in the embodiment depicted by FIGS. 1 and 2, each hole 106a, 106b of the second pair of holes 106 is sized to provide clearance between the fastener 107a, 107b of the second pair of fasteners 107 received by that hole 106a, 106b. Otherwise stated, the hole 106a, 106b is sized to allow a certain degree of play between the fastener 107a, 107b in the hole 106a, 106b. By this arrangement with the first leaf structure 101 in place against the panel 1001, each hole 106a, 106b of the second pair of holes 106 is sized to allow some slight variance in where the respective fastener 107a, 107b is applied. Specifically, instead of the hole 106a, 106b being matched with tight tolerance to the size of the fastener 107a, 107b such that the fastener 107a, 107b must be positioned dead-centre or substantially dead centre of the hole 106a, 106b, the fastener 107a, 107b may be applied slightly off-centre. This allows the installer of the hinge 1 some degree of selection of where the fasteners 107a, 107b are positioned within its respective hole 106a, 106b of the first leaf structure 101 for any given position of the first leaf structure 101 relative the panel 1001.

The provision of clearance between the holes of the first 104 and second pairs 106 and the fasteners 105, 107 received thereby may facilitate some adjustability of the hinge 1 position, which may facilitate some adjustability of an incorrectly placed fastener 105, 107, or to correct an incorrectly aligned panel 1001.

For example, an installer having attached the first leaf structure 101 to a panel 1001 by screwing each self-tapping fastener of the first pair 105a, 105b into the panel 1001 through a central or substantially central position within its respective first hole 104a, 104b, may notice that the hinge 1 is not correctly aligned such that the hinge axis is at a slight angle to its intended position (typically vertical). Such a misalignment may result in a panel attached to the hinge having a slightly tilted orientation, i.e. it may droop downwardly or angle upwardly, which may result in reduced functionality or poor aesthetics.

In this scenario it may be difficult to correct the hinge 1 orientation using the first pair of holes 104 as the fasteners 105 have created a hole in the panel 1001 within the footprint of the respective hole 104a, 104b in which it was applied. Removing and reinstalling the fastener 105a, 105b in a nearby position to the previously formed hole in the panel may reduce its purchase into the panel 1001, which may result in immediate or eventual failure. Accordingly, the installer may be required to remove the hinge 1 from the panel 1001 to fill the holes caused by the first fasteners 105 to ensure the slight repositioning of the fasteners 105 to correct the position of the hinge 1 results in a secure purchase between fasteners 105 and panel 1001. Such an operation may be time consuming in order to make slight angular adjustments to the hinge 1 position, and may result in the hinge 1 being incorrectly positioned a second time, causing further damage to the panel which may also need to be filled or the panel replaced.

Instead, and due to the clearance between the second fasteners 107 and second holes 106, the installer may select the position of said fasteners 107 within said holes 106 to apply a turning moment to the hinge 1 as the fasteners are driven into the panel, thus adjusting the angular orientation of the hinge 1. For example, in the case of FIG. 1, if the first hinge component 101 was attached to a panel 1001 (not pictured) via the first fasteners 105 received in the first pair of holes 104 such that the hinge 1 was tilted slightly counter-clockwise (i.e. if the hinge axis 10 was angled to the left of that shown, then the second leaf structure 201 would “droop” or angle downwardly compared to the first leaf structure 101. As a consequence, one or more further structures, for example, a panel 1002, attached to the second leaf structure 201 may also tilt downwardly. In order to correct this, the installer may select the position of the driving tip of either 107a, 107b or both of the second fasteners 107 at a lower location within the respective hole 106a, 106b. Then, as the fastener 107a, 107b is driven into the panel 1001, it acts against a lower wall of the hole 106a, 106b thus generating a turning moment on the hinge 1 that pulls the hinge axis 10 in a clock-wise position back into its proper vertical orientation. In this example the hinge 1 is not prevented from being tilted by this turning moment by the first pair of fasteners 105, as they are applied in an approximately central position in their respective hole thus having sufficient clearance to prevent or reduce abutment between the fastener 105a, 105b and the hole 104a, 104b periphery.

The order in which the first 105 and second 107 pair of fasteners are applied in the previous example may be reversed. Specifically, the installer may initially apply the second fasteners 106a, 106b in an approximately centered position within their respective holes 107a, 107b. Subsequently, the position of the first fasteners 105a, 105b within the first holes 104a, 104b may be selected to correct the hinge 1 orientation so that the hinge axis 10 is properly aligned, and that the panels 1001, 1002 are properly aligned.

Once the hinge 1 is correctly orientated using the first pair of fasteners 105 and the second pair of fasteners 107, the installer may apply the third pair of fasteners 109 into the centrally located third pair of holes 108. In certain embodiments, the third pair of holes 108 may also be configured with clearance to allow use of the third pair of fasteners 109 in adjusting hinge orientation, though in other embodiments, the third pair of fasteners 109 are more closely matched to the size of the third pair of holes 108 and thus are only used for securing the hinge 1 to the panel 1001. If the third holes 108 are endowed with clearance, they may offer a second opportunity to correct the position of the hinge 1 if unsuccessful using the first 105 or second 107 pair of fasteners. For example, if an adjustment attempt using one of the first 105 or second 107 pairs, the fasteners may be removed from that pair and the third pair 109 used to make the angular adjustment by selection of their position within their respective holes 108 in the same manner previously described.

In embodiments, only the third pair of fasteners 109 are required to provide a load-bearing duty. In such an embodiment, the first 105 and second 107 fasteners are not necessarily required to provide a load-bearing function over the functional life of the hinge 1 and panel 1001. Rather, they are only required to support the weight of the respective panel 1001 during the installation process in order to allow for initial attachment of the hinge 1 to the panel 1001 and fine adjustment of orientation, whereinafter the third fasteners 109 are applied to provide structural, load-bearing strength. Accordingly, the first and second pair of fasteners may have a smaller size than the third pair of fasteners.

Further, if the initial attachment of the first hinge component 101 via either of the first pair of fasteners 105 or the second pair of fasteners 107 results in the hinge 1 being correctly aligned, it may not be necessary to apply the other of the first pair of fasteners 105 or second pair of fasteners 107. Instead, as no adjustment of hinge 1 orientation is required, the installer may simply elect to apply the load-bearing third pair of fasteners 109. If so, hole caps (not shown) may be used to fill the un-used pair of holes.

As depicted in FIGS. 1 and 2, the hinge 1 may have a second leaf assembly 200 having a further leaf structure 201. For the purposes of clarity, throughout the remaining examples, the further leaf structure will be referred to as the second leaf structure. The second leaf structure 201 may feature the same arrangement of first 204, second 206 and third 208 pairs of holes as discussed supra in relation to the first leaf assembly 101, and accordingly may be used for fine adjustment of the hinge 1 orientation in an equivalent manner. In the depicted embodiments of FIGS. 1 and 2 the second leaf structure 201 is an identical mirror image to the first leaf structure 101 other than having complementary knuckles 210a, 210b, though other arrangements are possible. In the depicted embodiment, the first leaf structure 101 has a single intermediate knuckle 110 locating between upper 210a and lower 210b knuckles of the second leaf structure 201.

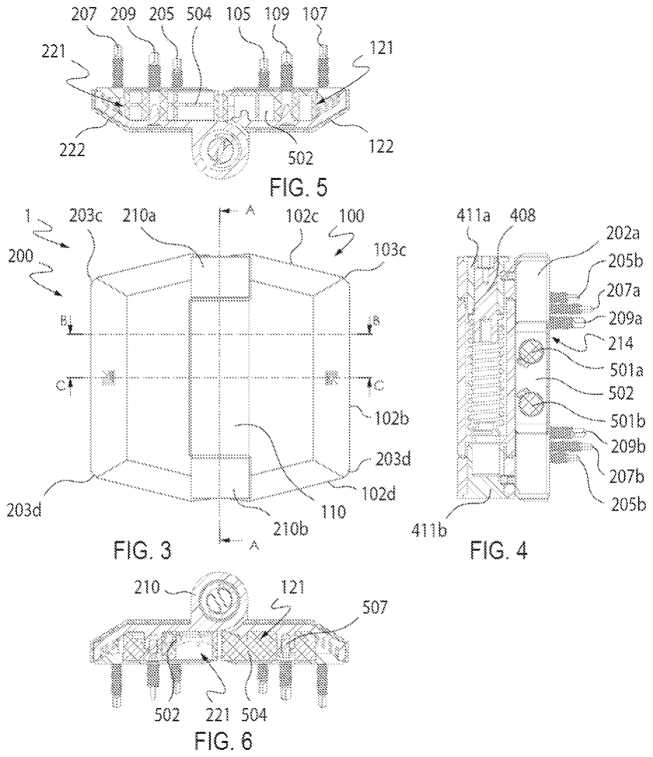

The knuckles 110, 210a, 210b of the first 101 and second leaf structure 201 in the assembled condition define a barrel 405 housing the spring 401 forming part of the bias structure 400. The spring 401 is operatively coupled to the first and second leaf assemblies 101, 201 to bias the first and second leaf assemblies 101, 201 to move from an open position to a closed position. The hinge 1 is shown in its closed position in FIGS. 3-5. In the closed position, the first 101 and second 201 leaf structures are substantially aligned and co-planar to each other such that the first and second panels 1010, 1020 (not shown) are substantially aligned and coplanar with each other. The spring 501 is preferably a torsional spring.

The first 101 and second 201 hinge components have an outer face 111, 211 and side walls 102, 202 that define at least in part one or more interior spaces 112, 212. As best seen in FIG. 2, the interior space 112, 212 of the depicted example embodiment is sectioned into three sub-spaces 112a, 112b, 112c, 212a, 212b, 212c by stiffening walls 113, 213, though the skilled addressee will appreciate many other suitable arrangements are possible. At least partially contained within the interior space 112, 212 of one of the first 101 or second 201 leaf structure is a dampener housing 502 forming part of the dampener assembly 500. At least partially contained within the interior space 112, 212 the other of the first 101 or second 202 leaf structure is a striking component 504. In the depicted example embodiment of FIG. 2 the dampener housing 502 is mostly contained within the interior space 112 of the first leaf structure 101 with a small portion of protruding from the interior space 112 in the direction toward the second leaf structure 201, said portion protruding through a gap 114 in the inner side wall 102a of the first leaf structure 101 defining in part the interior space 112. The gap 114 is adjacent the hinge axis 10. As depicted, the dampener housing 502 is adapted to reside in the mid subspace 112b of the interior space 112.

Similarly as depicted in FIG. 2, the striking component 504 is mostly contained within the interior space 212 of the second leaf structure 201 with a small portion protruding from the interior space 212 towards the first leaf structure, said portion protruding through a gap 214 in side wall 202a of the second leaf structure 201 defining in part the interior space 212, said gap 214 located adjacent the hinge axis 10. As with the first hinge component 101, the internal space 112 may include stiffening walls 213. The stiffening walls 213 may define sub spaces in the interior space 212. The depicted embodiment includes three such subspaces: an upper subspace 212a, a mid subspace 212b and a lower subspace 212c. The internal space 112 or a portion thereof may be shaped to engagingly receive the striking component 504. In the depicted example, the stiffening walls 213 correspond with at least part of the upper and/or lower side walls of the striking component so that it is engagingly received in the mid subspace 112b.

The holes of the first 104, 204, second 106, 206 and/or third 108, 208 pair may be defined in part by bosses 115, 215 within the interior space. In the example embodiment depicted, the bosses 115, 215 are buttressed by the stiffening walls 113, 213 traversing a portion of the interior space 212 to add strength and/or rigidity to the leaf structure 101, 201. The dampener housing 502 and/or the striking component 504 may be shaped to correspond to a certain portion of the interior space 112, 212 to ensure correct positioning and to resist movement due to opening and closing forces. In the example embodiment of FIG. 2, both the dampener housing 502 and the striking component 504 have scallops or formed in their upper and lower sidewalls that correspond to screw bosses 115, 215 of the third pair of holes 108, 208, however recesses, protrusions and engaging features of any type may be used.

As depicted, the placement of the dampener housing 502 and/or striking component 504 within the interior space 112, 212 with the bosses 115, 215 of the third pair of holes 108, 208 locating within the scallops 505 ensures the correct positioning of the dampener housing 502 and/or striking component 504. When in this position a securing boss/screw tube 116, 216 locating in interior space 112, 212 protrudes into a corresponding aperture 506 of the dampener housing 502 and/or striking component 504, allowing the dampener housing 502 and/or striking component 504 to be retained in its correct position by applying a screw 507 or the like through the aperture 506 and into the screw tube 116, 216.

The dampener housing 502 is part of a dampener assembly 500, which may further include at least one dampener 501. The dampener housing 502 has at least one cavity 503 to receive the at least one dampener 501. The example embodiment of FIGS. 1 and 2 include a dampener housing 502 having two cavities: an upper 503a and lower cavity 503b each receiving an upper 501a and lower 501b dampener respectively. However, it will be appreciated that depending upon the amount of bias provided by the spring 174, a single dampener 124 may be sufficient, in which case the dampener assembly 131 may be selectively installed to include a single dampener 124. In other example embodiments, the housing 502 may have greater than two cavities 503.

The dampener 501 is configured to slow movement of the first and second leaf assemblies 100, 200 to the closed position. The first and second leaf assemblies 100, 200 are biased into the closed position by the spring 401 of the bias structure 400. In the example embodiment depicted, a striking surface 508 of the striking component 504 contacts the dampeners 501a, 501b in an extended position when approaching the closed position, wherein the dampeners 501a, 501b slowly move to a retracted position whilst absorbing some of the momentum and force of the hinge 1 approaching the closed position. In one specific example, the longitudinal axis of the dampeners 501a, 501b extends orthogonal to the hinge axis 10. In this arrangement, at least a portion of the dampener 501 protrudes outwardly from a dampener housing 502 of the first hinge leaf assembly 100 when the hinge 1 is located in the non-closed position. When the hinge 1 approaches the closed position, the extended portion of the dampener 501 comes into contact with the striking surface 508 of the striking component 504 and slowly retracts within the dampener housing 132 in the manner known as soft-close functionality. It will be appreciated that the dampeners 501a, 501b come into non-continuous contact with the opposing leaf assembly/striking surface.

The longitudinal axis of the one or more dampeners 501 are located between the hinge axis 10 and the first panel 1010 as disclosed in PCT/AU2021/051056. In a preferable form, the longitudinal axis of the dampener 501 is substantially equidistantly located between the hinge axis 10 and the first panel 1010. This arrangement means that unlike the soft close hinge disclosed in PCT/AU2017/050133 where the dampener is located coplanar with the panel, the dampener in the current hinge 1 is located behind the panel 1010 and between the hinge axis 10 and the face of the panel 1010.

The dampener housing 502 can include one or more cavities 503 for accommodating the one or more dampeners 501. Each cavity 503 includes a longitudinal axis which extends orthogonal to the hinge axis 10. Each cavity 503 is generally cylindrical in cross-section for accommodating a generally cylindrical body of the dampener 501. As disclosed in PCT/AU2021/051056, each dampener 501 may include a first dampener portion provided in the form of a pin which extends and retracts within a second portion of the dampener 501 provided in the form of the dampener body or cylinder. Each dampener 501 is generally provided in the form of a hydraulic dampener, wherein the dampener body contains a hydraulic fluid which is used to provide the dampening functionality. The dampener body may contain a spring or biasing mechanism and operatively coupled to the first dampener portion to bias the first dampener portion to extend from the second dampener portion.

As disclosed in PCT/AU2021/051056 a portion of the dampener 501 body extends from the cavity 530 when the hinge 1 is moved from the open position to the closed position. When the hinge 1 moves toward the closed position, the end of the dampener 501 body comes into contact with the striking surface 508 of the striking component 504 to abuttingly retract within the cavity 503 as the dampener pin is received within the dampener body under bias of the spring 401 of the bias structure 400. As disclosed in PCT/AU2021/051056, the end wall of each cavity 320 may include a small hole to receive and resiliently retain the tip of the dampener pin and thus the dampener 501. In one form, said small hole can be provided in the form of a pair of orthogonal slits having a generally cross profile provided in the end wall of the cavity 503, wherein the tip of the pin is resiliently received in the centre of the cross-shaped hole.

When the hinge 1 moves from the closed position to the open position, a portion of the dampener 501 extends and protrudes outwardly from the dampener housing 502. A majority of the dampener body of a respective dampener 501 is housed within the respective cavity 503 in the closed position, and upon moving the hinge to an open position, a majority of the dampener body may locate outside the respective cavity 503. When the hinge 1 is moved to an open position under an external force (i.e. a user opens a hinge gate which includes the hinge 1), a portion of the dampener body may extend from the cavity 503 under the bias of a spring contained within the dampener body.

The striking component 504 may have an identical, substantially identical or similar shape to the dampener housing 502. The striking component 504 may be secured within an interior space 212 of the second leaf structure 201 in an equivalent manner to how the dampener housing 502 is secured within the interior space 112 of the first leaf structure hereinbefore described. A portion of the interior space 212 of the second leaf structure 201 may be shaped in relief or otherwise to correspond to the shape of the striking component 504 in order to receive the striking component 504 in its correct location within the interior space 212. As with the dampener housing 502, the striking component 504 may be scalloped 505 to receive bosses 215 protruding into the interior space 212 that define in part one or more individual holes of the first 204, second 206 or third 208 pairs of holes. A further bossed screw tube 216 may extend into the interior space 212 to be received by a corresponding aperture 506 in the striking component 504 body, such that a screw 507 or the like can be used to securely fasten the striking component to the second leaf structure.

The striking component 504 may locate between the hinge axis 10 and the second panel 1002. The striking component 504 may include a striking surface 508 which may locate in an adjacent and opposing relationship to the protruding dampener 501 ends of the dampener assembly 500 in the closed position. The striking surface 508 may include one or more indents 509, each of which configured to contact with the end of the dampener 501 body when moving toward the closed position.

In the depicted embodiment of FIGS. 1 and 2, dampener housing 502 and the striking component 504 have a similar shape, albeit the cavities 320 are not being provided in the striking component 504, such that the dampener housing 502 and striking component 504 have substantially matching perimeter profiles. This arrangement may be advantageous as portions of tooling for manufacturing the dampener component 132 and striking component 134 can be duplicated. The relative position of the housing 502 and striking component 504 in the first 101 and second 201 leaf structures may also be swapped if desired.

Both the first leaf assembly 100 and the second leaf assembly 200 may have a rear cover 117, 217. The dampener housing 502 may reside between the first leaf structure 101 and the first rear cover 117. The dampener housing 502 may have a substantially planar rear surface which may sit flush with an inner surface 118 of the first rear cover 117. As depicted in FIG. 1, the inner surface 118 of the first rear cover 117 may feature strengthening walls 119 and/or ribs to stiffen the rear cover 117. Some or substantially all of these strengthening 119 walls may be oppositely arranged to the stiffening walls 113 of the first leaf structure 101 when the hinge 1 is in its assembled condition with the rear cover 117 at least partially covering the interior space 112, which may improve the over-all strength of the hinge 1. The inner surface 118 of the rear cover 117 may also feature an interior space 120 which may correspond to at least a portion of the dampener housing 502 in relief or have otherwise engaging features so as to engagingly receive the dampener housing 502 when the hinge 1 is in its connected condition. This portion of the rear cover 117 shaped as part of the dampener housing 504 in relief may cooperate with the equivalent portion of the interior space 112 of the first leaf structure 101 to define the cavity 121 for receiving the dampener housing 502. The interior space 112 of the first leaf structure and the interior space 120 of the rear cover 117 cooperate to define said cavity 121.

Similarly, the striking component 504 may reside between the second leaf structure 201 and the second rear cover 217. The striking component 504 may have a substantially planar rear surface which may sit flush with an inner surface 218 of the second rear cover 218. As depicted in FIG. 1, the inner surface 218 of the second rear cover 217 may feature strengthening walls 219 and/or ribs to stiffen the rear cover 217. Some or substantially all of these strengthening 219 walls may be oppositely arranged to the stiffening walls 213 of the second leaf structure 201 when the hinge 1 is in its assembled condition with the rear cover 217 at least partially covering the interior space 212, which may improve the over-all strength of the hinge 1. The inner surface 218 of the rear cover 217 may also feature an interior space 220 which may correspond to at least a portion of the striking component 504 in relief or have otherwise engaging features so as to engagingly receive the striking component 504 when the hinge 1 is in its connected condition. This portion of the rear cover 217 shaped as part of the dampener housing 504 in relief may cooperate with the equivalent portion of the interior space 212 of the second leaf structure 201 to define the cavity 221 for receiving the striking component 504. The interior space 212 of the first leaf structure and the interior space 220 of the rear cover 217 cooperate to define said cavity 221.

Both the first rear cover 117 and the second rear cover 218 are shaped to have the same profile as the first 101 and second 201 leaf structures. By this arrangement, the rear covers 117, 217 and leaf structures 101, 201 occupy the same or substantially the same foot print when the hinge 1 is in place with the rear covers 117, 217 against respective panels, such that the access to the rear cover 117, 217 is obscured by the leaf structures 101, 201. In the depicted embodiments the leaf structures 101, 201 and the rear covers 117, 217 have a trapezoidal shape, specifically an isosceles trapezium in this embodiment, though other arrangements are possible. The rear cover 117, 217 features a series of holes matched to the first 104, second 106 and third 108 pair of holes, such that the respective fasteners may pass through the holes of the rear cover and into the panel 1000. A hole is also provided on the rear covers 117, 217 for access to the screws 507 securing the dampener housing 502 and the striking component 504.

Both the first leaf assembly 100 and the second leaf assembly 200 may also have a front cover 122, 222 for placement over the outer face 111,211 of the first 101 and second 201 hinge components. The front cover 122, 222 may aid in protecting other components of the first and/or second hinge leaf assemblies 100, 200. For example, the front cover 122,222 may shield fasteners 105, 205, 107, 207, 109, 209 from atmospheric conditions such as rain that may lead to corrosion and failure. The front cover 112, 222 may also shield the first 101 and second 201 leaf structures from UV damage which may eventually lead to failure. The inner surface 123, 223 of the front 112, 222 cover may be substantially matched in relief to the shape of the leaf structure 101, 201 to which it attaches. Small inwardly projecting clips be may provided on inner edge peripheries of the front cover 112, 222 so that it clips in place over the leaf structures 101, 201. The outer surface 125, 225 of the front cover 112, 212 may have the same or substantially similar appearance to the outer surface 111, 211 of the first and second leaf structures 101, 201. In the depicted embodiments, the leaf structures 101, 201 have a profile shaped as an isosceles trapezium with the upper 102c, 202c and lower edges 102d, 202d angling inwards towards the outer edge 102b, 202b. The outer surface 125, 225 has a wide chamfer towards the sidewalls/edge peripheries 102,202, and the corner peripheries 103, 203of the sidewalls are chamfered.

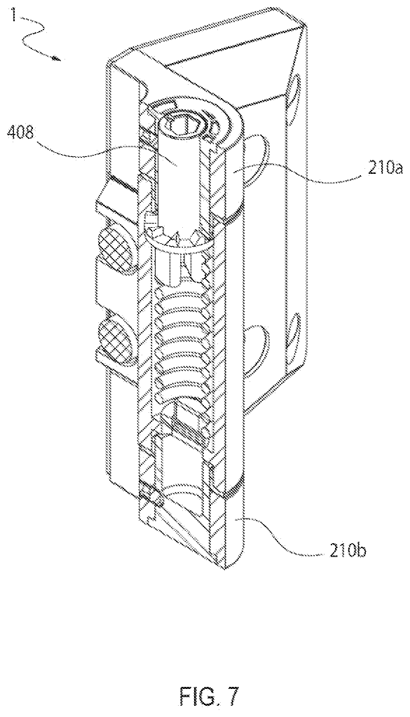

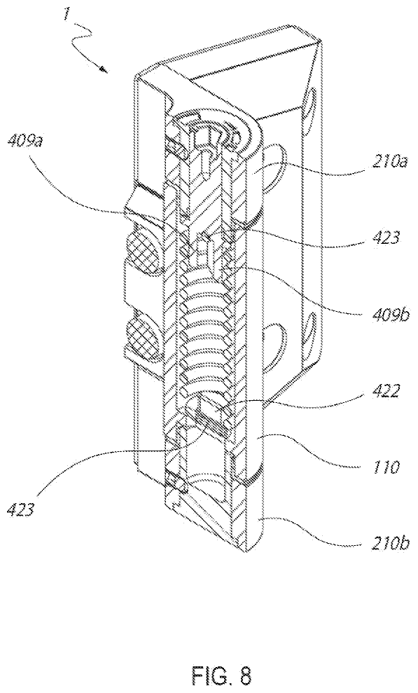

Referring now to FIGS. 3 to 8, the second hinge leaf assembly 201 includes a plurality of knuckles 210, specifically top 210a and bottom knuckles 201b, and the first leaf assembly 101 includes a further knuckle 110, specifically an intermediate knuckle 110. The knuckles 110, 210a, 210b are coaxially aligned along hinge axis 10 to define a barrel 410 housing the spring 401. The intermediate knuckle 110 has a length that corresponds to the spacing between the top and bottom knuckles 210a, 210b. The knuckles 110, 210 have a substantially ring-like profile. Bushes may be located between the adjacent surfaces of the end and intermediate knuckles 110, 210 to minimise friction between the first and second leaf assemblies 101, 201 during rotational movement about the hinge axis 10 when being moving between opened and closed positions.

The hinge 1 may include a top and bottom barrel cap 411a, 411b to substantially enclose the barrel 410 of the hinge 1. The end knuckles 210a, 210b include a hole 226a, 226b extending through the ring-shaped wall of said knuckles. The top and bottom barrel caps 411a, 411b also include a hole 412a, 412b in an outer neck 413a, 413b which aligns with the holes 412a, 412b in the top and bottom knuckles 210a, 210b. A fastener, such as a grub screw 414a, 414b, can be received through the aligned holes 412 in knuckles 210 with the holes 412 in the barrel caps 411 such that the barrel caps 411 are coupled to the second hinge leaf assembly 201. Thus, the barrel caps 411 do not rotate relative to the second hinge leaf assembly 201 in the event that the grub screws 414 are in place.

The top barrel cap 411a includes an outer neck 413a and an inner neck 415a, wherein the inner neck 415a has a void 416 which houses a neck portion 418 of a torsion adjustment structure 408. The upper surface of the upper cap 411a includes a plurality of markings 419 indicative of the direction and torsion gradation of the spring 401. The bottom edge of the neck of the top barrel cap 411a includes a first engaging surface 420 provided in the form of a sawtooth profile. The torsion adjustment structure 408 cooperates with the top barrel cap 411a. The torsion adjustment structure 408 is located within the inner neck 415a of the top barrel cap 411a. The torsion adjustment structure 408 has a neck 418 which extends from a shoulder 417. An upper surface of the shoulder 417 has a second engaging surface 421 which cooperatively engages with the first engaging surface 420 of the neck of top barrel cap 411a to restrict rotational movement of the torsion adjustment structure 408 relative to the top barrel cap 411a.

The torsion adjustment structure 408 is coupled to a first end of the spring 401. In particular, the spring 401 includes a diametrically extending tail 404 defining a first and second cavity 406, 407 with coils of the spring 402. In embodiments like that depicted, the first cavity 406 and the second cavity 407 join to become a single space within the spring as defined by the coils 402. The torsion adjustment structure 408 includes a pair of protrusions 422a, 422b which are received within the respective first and second cavities 406, 407 of the spring 401 to enable the rotational force applied to the torsion adjustment structure 408 to be transferred to the spring 401 to adjust the torsion of the spring 401. The protrusions 422 have a “D-shaped” cross-sectional profile. The spring 401 includes a further diametrically extending tail 423 received within an aperture 126 located in a wall extending across the intermediate knuckle 110 of the barrel 410 which is part of the first hinge leaf assembly 101. The wall extending across the lower end of the intermediate knuckle 110 may include upwardly extending protrusions which are received within corresponding cavities defined by coils 402 of the spring 401 and the further diametrically extending tail 423 to couple the spring 401 to the barrel 410. The upper end of the neck of the torsion adjustment structure 408 includes a tool hole 424 to allow an operator to apply a rotatable force to the torsion adjustment structure 408 to adjust the torsion applied by the spring 401.

In use, a user applies a rotational force to the torsion adjustment structure 408 via a tool like an Allen key or the like, though other arrangements are equally possible such as a tab or the like that allow adjustment without an additional tool. When a rotational force is applied, the trailing edges slide over the leading edges to allow the rotational movement of the torsion adjustment structure 408 relative to the top barrel cap 411a, which in turn increases the torsion applied by the spring 401. Each tooth of the first engaging surface 420 has a substantially vertical trailing edge which cooperates with a substantially vertical leading edge of a respective tooth of the second engaging surface 421. These vertical edges engage against each other and restrict rotational movement of the top barrel cap 411a relative to the cap 408 which is under bias from the spring 401. In the event that a downward force is transferred by the user along the hinge axis 10 to compress the spring 401 within the barrel 410 to disengage the first engaging surface 420 from the second engaging surface 421, the torsion can be decreased as the torsion adjustment structure 408 can rotate under bias from the spring 401 relative to the top barrel cap 411a.

The torsion adjustment structure 408 can be adjusted accordingly to ensure that the hinge 1 returns to the closed position under appropriate bias from the spring 401 of the bias structure 400 whilst being sufficient dampened by the dampening assembly 500.

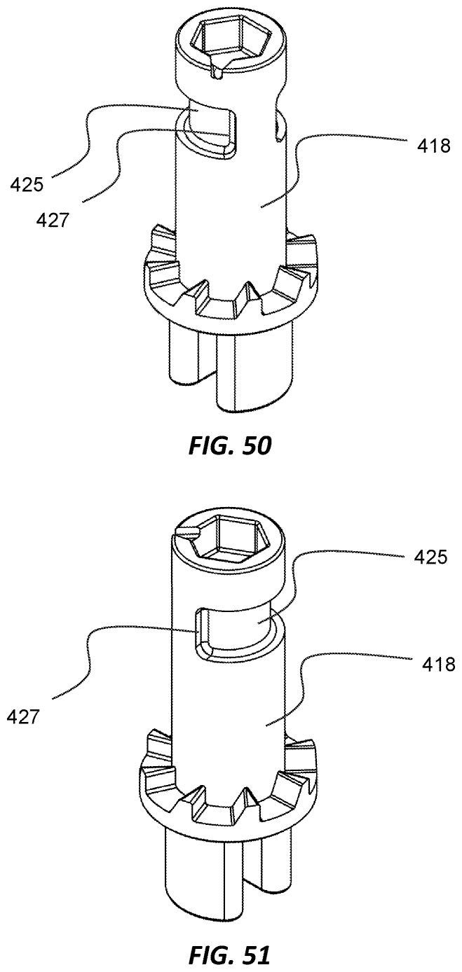

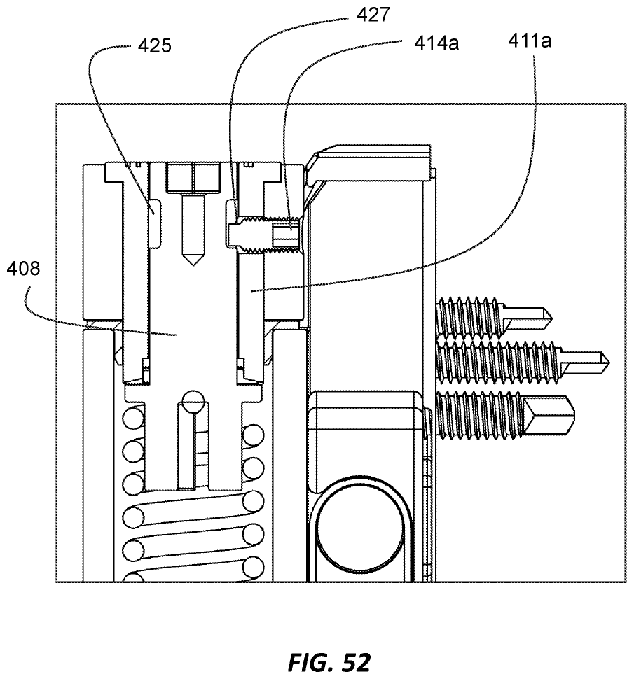

An alternative embodiment the torsion adjustment structure 408 configured to restrict adjustment of the storage of potential energy by the spring 401 beyond a predetermined limit is disclosed below in relation to FIG. 50-52.

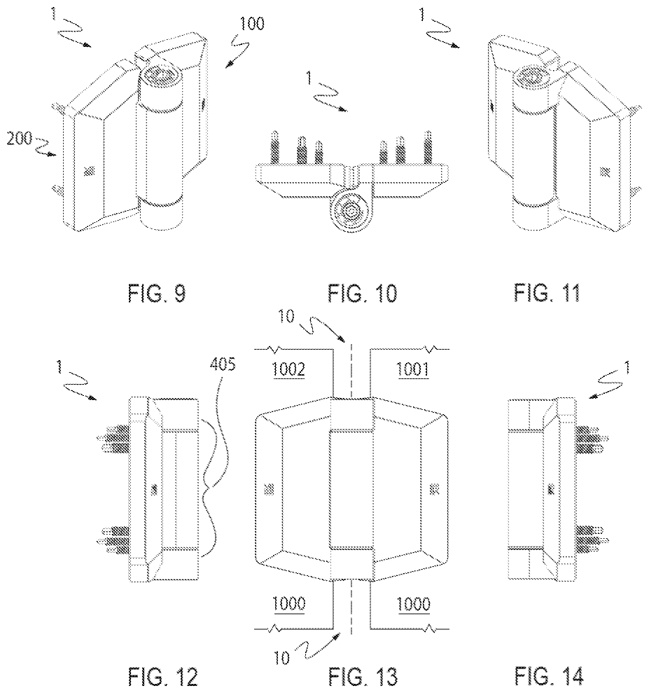

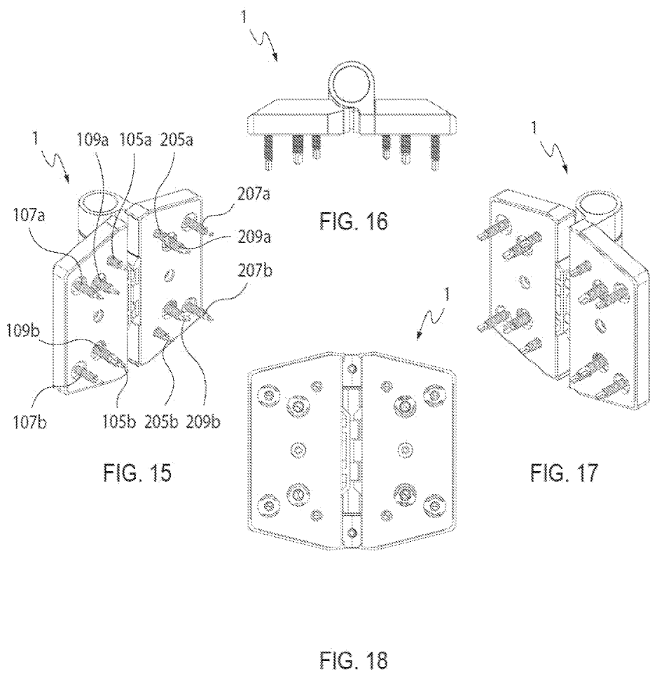

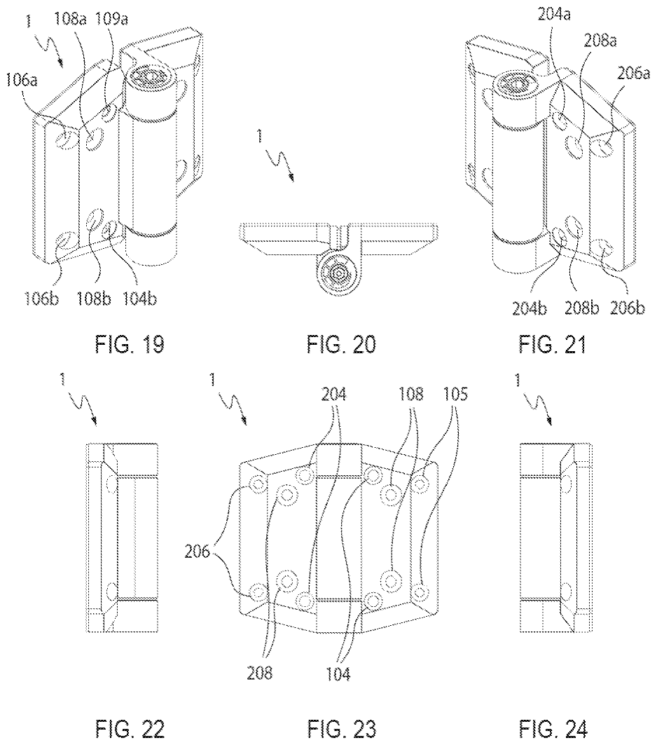

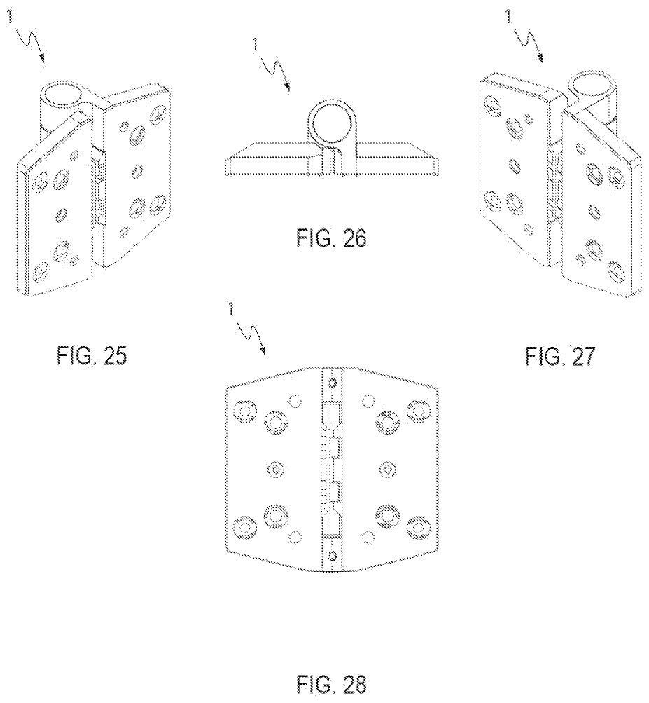

Referring now to FIGS. 9 to 18, shown are various views of the hinge 1 in an assembled condition. Referring to FIG. 13 in particular, shown is the hinge 1 in place on structures 1001, 1002, such as the first and second panels 1001, 1002. The panels may be formed of any suitable material such as glass, wood or metal. One of the panels may be fixed in its position such that the other of the panels has a gate-like functionality with the open and closed positions of the hinge allowing that panel to be similarly opened and closed. FIGS. 19 to 28 repeat the view of FIG. 9 to 18 for a hinge absent of the front covers and fasteners.

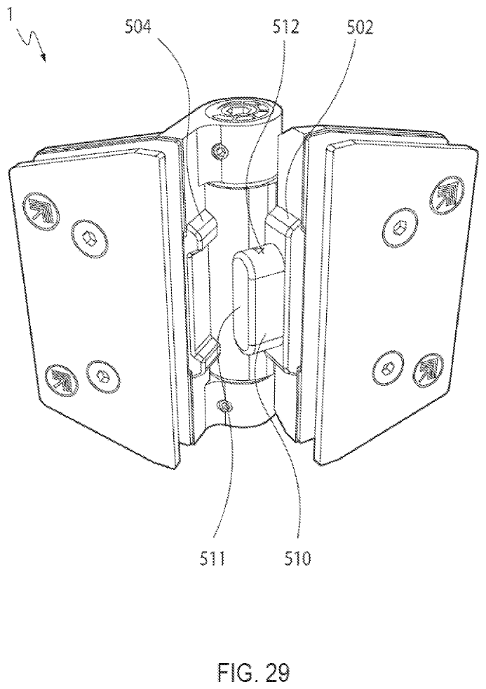

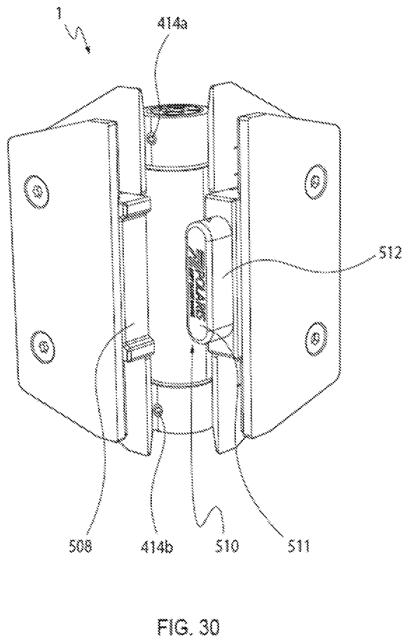

Referring now to FIGS. 29 and 30, shown is an embodiment of a hinge 1 wherein the dampener assembly 500 includes a cover member 510 covering the dampeners 501. The cover member 510 fits over the ends of the dampers 501 which would usually protrude from the dampener housing 502 when the hinge 1 is in the open position as hereinbefore described. The cover member 510 thus acts as an intermediary between the striking surface 508 of the striking component 504 and the dampeners 501.

The cover member 510 has an outer surface 511 for contacting the striking surface 508. The cover member 511 has side walls 512 that cooperate with the outer surface 511 to define an interior space (not shown) which can accommodate the protruding ends of the dampeners 501 from the dampener housing 502. By this arrangement, the cover member 510 covers the ends of the dampeners 5014 and encloses or at least partially encloses the cavities 503 so the dampeners 501 are contained within the housing 504 in cooperation with the cover member 510. This is turn may restrict access to the dampeners 501. This arrangement may be advantageous in protecting the dampeners 501 against atmospheric conditions and the ingress of debris. In the embodiment where the dampener housing 502 is adapted to receive multiple dampeners 501 allow the installer to select the number of dampeners 501 used as hereinbefore described, the cover member 501 may visually obscure an observer from noticing unused space which may give the impression a dampener 501 is missing and the hinge 1 has not been properly installed. For example, if the dampener housing 502 has multiple cavities 503 for respectively receiving multiple dampeners 501, and the installer determines some amount of dampeners 501 less than the maximum is required to off-set the bias structure 400, the cover member 510 may prevent an observer noticing that there are empty cavities 503, which they may interpret as meaning the hinge 1 was incorrectly installed. Such empty cavities 503 may also suffer from debris ingress complicating the addition of further dampeners 501 at some other time, and may also serve as a space to host unwanted pests, such as spiders.

The cover member 510 is adapted for sympathetic movement with the plungers 501. In an open position of the hinge 1 like that pictured, the cover member 510 protrudes significantly form the dampener housing 502, as do the dampeners 501 ends contained within the cover member 50. As the hinge 1 is brought into the closed position and the cover member 510 contacts with the striking surface 508, the cover member 510r is pushed into the dampener housing 502, transferring this force to the dampeners 501 that are also pushed into the dampener housing 502 as hereinbefore described. In embodiments, the side walls 512 of the cover member 510 may extend into the dampener housing 502 even when protruding therefrom in the open position shown. In another embodiment, the cover member 510 may have “legs” extending into the dampener housing, rather than continuous side walls. Engaging features (not shown) within the interior space of the cover member 510 may releasably attach with the dampener(s) 501 to facilitate co-movement. For example, the engaging features may facilitate a press fit between dampeners 501 and the cover member 510, so that the cover member 510 can be pulled to disengage from the dampeners 501 allowing access to dampeners 501 for reconfiguring or replacement, whereinafter the cover member 510 may be simply pushed back into position with the dampener housing 502.

The cover member 510 may be adapted to be limited to travel along a single axis. For example, in the depicted embodiments, the portion of the dampener housing 502 receiving the legs or extending sidewalls may be sized to match the shape of said legs or extending sidewalls so that movement of the cover member 510 is limited into and out of the dampener housing 502, that is, movement of the cover member 510 is limited to linear movement along the longitudinal axis of the dampeners 501. Accordingly, the force transferred to the dampeners 501 by the cover member 510 is linear along the longitudinal axis. This arrangement may therefore act to prevent or reduce side load forces to the dampeners 501 owing the dampener assembly 500 being offset from the hinge axis 10, i.e. an inner portion of an uncovered dampener 501 closest hinge axis 10 would contact the striking member 508 ahead of an outer portion as the hinge 1 is moved toward the closed position thus creating a side load which may damage the dampener 501 over time.

The example embodiments of FIGS. 29 and 30 show a clamping style hinge 10 like that described in PCT/AU2021/051056, however it is to be understood that the face mounted hinge of FIGS. 1 to 28 may use a cover member in the same manner.

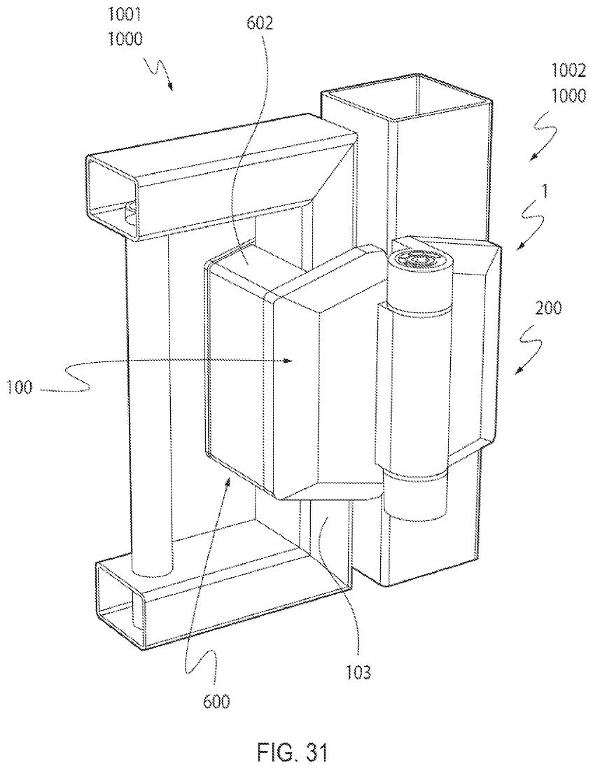

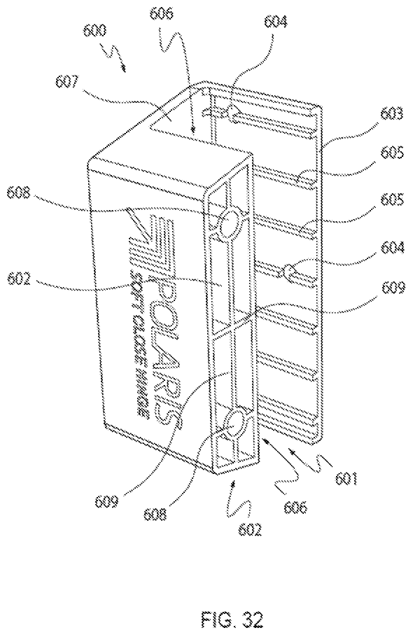

Referring now to FIGS. 31 and 32, shown is an adapter 600 facilitating connection of a hinge 1 to a panel 1000 that is not of a sufficient dimension to accommodate the foot print of the first or second leaf assembly 100, 200. In the example embodiment of FIG. 31, the second leaf assembly 200 is mounted to a structure, such as panel 1002 provided in the form of an elongated post having sufficient width to accommodate the second leaf assembly 200. However, the first leaf assembly 100 is to be mounted to a panel 1001 in the form of a metal gate having an exterior frame 1003 of insufficient width to accommodate the first leaf structure 101 such that some of the fasteners 105a, 105b, 107a, 107b, 109a, 109b cannot be applied to the panel 1001.

The adaptor 600 shown in FIG. 32 has a channel 601 shaped to receive part of the panel frame 1003. The adaptor 600 also has a screw block 602 offering additional space to receive fasteners when the adaptor 600 is in place with the channel 601 receiving the frame 1003.

In the embodiment shown, the adaptor 600 has a profile shaped in correspondence with the footprint of the hinge 1. A generally U-shaped channel 601 is formed in the adaptor 600 dimensioned to receive the frame 1003. The channel 601 is sized to match the frame 1003 dimensions with a close or substantially close tolerance. In use, the walls defining the channel 601 will surround three sides of the frame 1003 with the fourth side contacting with the mounting face of the first leaf assembly 601 such that a portion for the frame 1003 is bound by the adaptor 600 in cooperation with the first leaf assembly 100.

Defining the channel 601 in part is an inner side wall 603. The inner side wall 603 may have a depth equivalent to that of the frame 1003 side to which it attaches. Aperture 604 may be formed in the inner wall 603 to facilitate attachment of the adaptor 600 to the frame 1003 using screws or the like (not shown). It may be advantageous to attach the adaptor 600 to the frame 1003 using the inner wall 603 as opposed to other walls, as fasteners applied therethrough will engage with an outer side of the frame 1003 and thus be visually obscured by post 1002 when the hinge 1 is in the closed position of FIG. 31. The inner wall 603 may also have strengthening ribs 605 as shown.

Opposite to the inner side wall 603 is the outer wall 606 also defining the channel 601 in part. As depicted, the outer wall 606 is part of the screw block 602. The depth of the outer wall 606 is equivalent to that of the frame 1003 side to which it attaches, which is the same depth as the inner wall 603 in the depicted embodiment. A rear wall 607 connects the inner 603 and outer walls 606 to define the channel 601.

When the adaptor 600 is attached to the frame 1003 of panel 1001 with a frame portion received in the channel 601, the screw block 602 acts to extend the surface of the frame 1003 thus providing additional space to receive fasteners 105a, 105b, 107a, 107b, 109a, 109b. In the depicted embodiment, the frame 1003 is of sufficient dimension to receive the first 105 and third pair 109 of fasteners, but not the second 107. Apertures 608 may be provided in the screw block 602 to receive the second fasteners 107. In the depicted embodiment of FIG. 32, the screw block 602 in not solid, but rather has a webbed construction with intersecting strengthening walls 609. The apertures 608 are in the form of screw tubes buttressed by the strengthening walls 609 for additional strength.

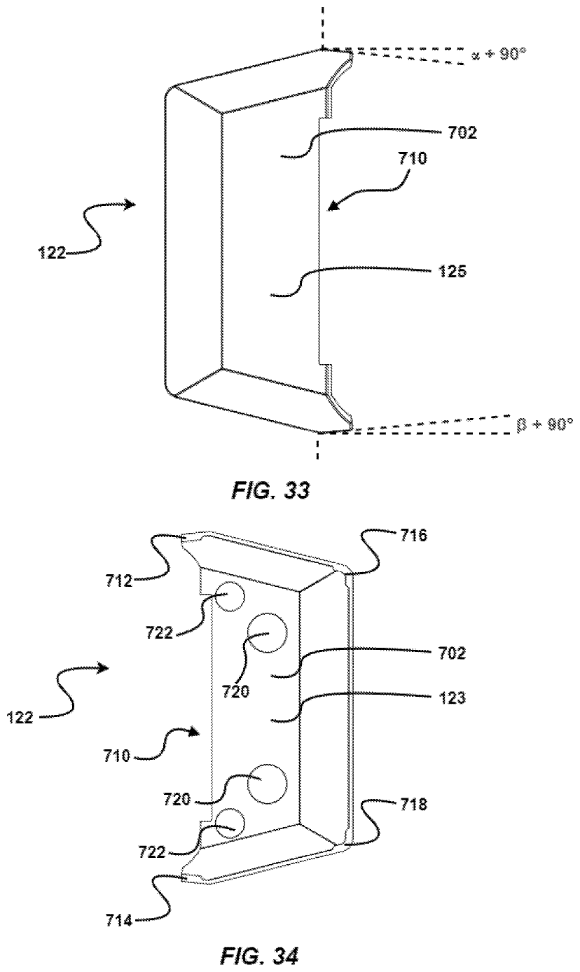

Referring to FIGS. 33 to 40, there are shown schematics of the first front cover 122 and the second front cover, isolated from the hinge, for placement over the respective outer faces 111, 211 of the first 101 and second 201 hinge components.

Each cover 122, 222 includes a main cover body 702, 780 having a lip 704, 706 extending partially about a periphery thereof. Ends of the lip 704, 706 define a mouth 710, 754 for receiving the leaf structures 101, 201 of the hinge. A first clip 712, 750 and second clip 714, 752 project outwardly from opposing sides of the mouth 710, 754. The first and second clip 712, 750, 714, 752 are resiliently biased and inwardly angled toward each other to resiliently engage the leaf structures 101, 201 when received within the mouth 710, 754.

As mentioned above, the first and second front cover 122, 222 aid in protecting other components of the first and second hinge leaf assemblies 100, 200. For example, the first and second front cover 122, 222 can shield fasteners 105, 205, 107, 207, 109, 209 from atmospheric conditions such as rain that may lead to corrosion and failure. The front cover 112, 222 may also shield the first 101 and second 201 leaf structures from ultra-violet light damage which may eventually lead to failure.

As mentioned above, the inner surface 123, 223 of the first and second front cover 112, 222 can substantially match in relief to the accommodate the shape of the respective leaf structure 101, 201 to which it attaches. In particular, the first and second front cover 112, 222 have a shell-like profile with the open mouth 710, 754 facing the knuckles/barrel during installation for receiving the respective leaf structure 112, 222.

Clips 712, 714, 750, 752 of the covers 122, 222 project inwardly relative to the hinge axis when installed. The clips 712, 714, 750, 752 are located on inner edge peripheries of the front cover 112, 222 so that the respective cover clips are placed over the leaf structure 101, 201 with a snap-fit engagement due to the projecting clips 712, 714, 750, 752 being resilient. Each cover 122, 222 are an integral one-piece component made from plastic or metal to provide the snap-fit resiliency. In embodiments where the covers are made from metal, the covers may be made of stainless steel.

The first and second clip 712, 714 of the first cover 122 is inclined inwardly toward each other. More specifically, as shown FIG. 33, an upper surface of the first clip 3560 is angled inwardly and offset by an angle α+90 degrees relative to the hinge axis. As also shown in FIG. 33, a lower surface of the second clip 3630 is angled inwardly and offset by an angle β+90 degrees relative to the hinge axis. This inward angular offset of the clips 3560, 3650 in combination with the resilient nature of the clips 3560, 3650 allow for positive engagement of the first cover 122 with the first leaf structure 101. In one form, the angular offset is between approximately 92° and 100° relative to the hinge axis, and more preferably between approximately 93° and 97° relative to the hinge axis, and even more preferably between approximately 95° and 96° relative to the hinge axis.

The first and second clip 750, 752 of the second cover 222 is inclined inwardly toward each other. More specifically, as shown FIG. 38, an upper surface of the first clip 750 is angled inwardly and offset by an angle γ+90 degrees relative to the hinge axis. Also as shown in FIG. 38, a lower surface of the second clip 752 is angled inwardly and offset by an angle δ+90 degrees relative to the hinge axis. This inward angular offset of the clips 3710, 3720 in combination with the resilient nature of the clips 3710, 3720 allow for positive engagement of the second cover 222 with the second leaf structure 201. In one form, the angular offset is between approximately 92° and 100° relative to the hinge axis, and more preferably between approximately 93° and 97° relative to the hinge axis, and even more preferably between approximately 95° and 96° relative to the hinge axis.

Due to the snap-fit engagement of each cover 122, 222 with the leaf structures 101, 201, the covers 122, 222 can be quickly installed into engagement which is advantageous over other designs where screws are required to hold the cover in place. Furthermore, due to the resilient nature of the clips, a user can lift the clips away from the surface of the hinge to disengage the clips, thereby allowing for the covers to be disengaged from the leaf structures 101, 201.

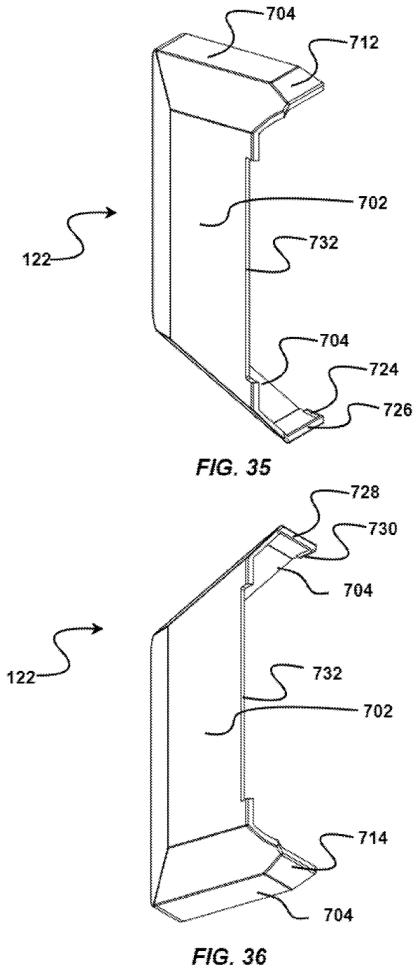

As shown in FIGS. 35 and 36, the first clip 712 of the first cover 122 has a first and second clip ridge 728, 730. The clip ridges 728, 730 are defined about the perimeter of the first clip 712. Similarly, the second clip 714 of the first cover 122 has a first and second clip ridge 726, 724. The clip ridges 726, 724 are defined about the perimeter of the second clip 714. The first clip ridges 726, 728 extend substantially orthogonally to the second clip ridges 724, 730 to aid in engaging the leaf structure in orthogonal directions.

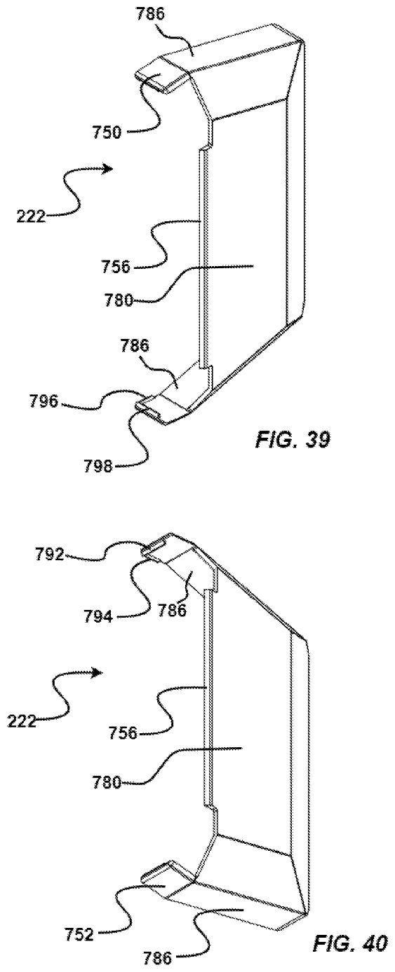

As shown in FIGS. 39 and 40, the first clip 750 of the second cover has a first and second clip ridge 792, 794. The clip ridges 792, 794 are defined about the perimeter of the first clip 750. Similarly, the second clip 752 of the second cover 222 has a first and second clip ridge 798, 796. The clip ridges 796, 798 are defined about the perimeter of the second clip. The first clip ridges 792, 798 extend substantially orthogonally to the second clip ridges 794, 796 to aid in engaging the leaf structure 201 in orthogonal directions.

The outer surfaces 125, 225 of the front covers 112, 212 have the same or substantially similar appearance to the outer surface 111, 211 of the first and second leaf structures 101, 201. In the depicted embodiments, the leaf structures 101, 201 have a profile shaped as an isosceles trapezium with the upper 102c, 202c and lower edges 102d, 202d angling inwards towards the outer edge 102b, 202b. The outer surface 125, 225 has a wide chamfer towards the sidewalls/edge peripheries 102,202, and the corner peripheries 103, 203 of the sidewalls are chamfered.

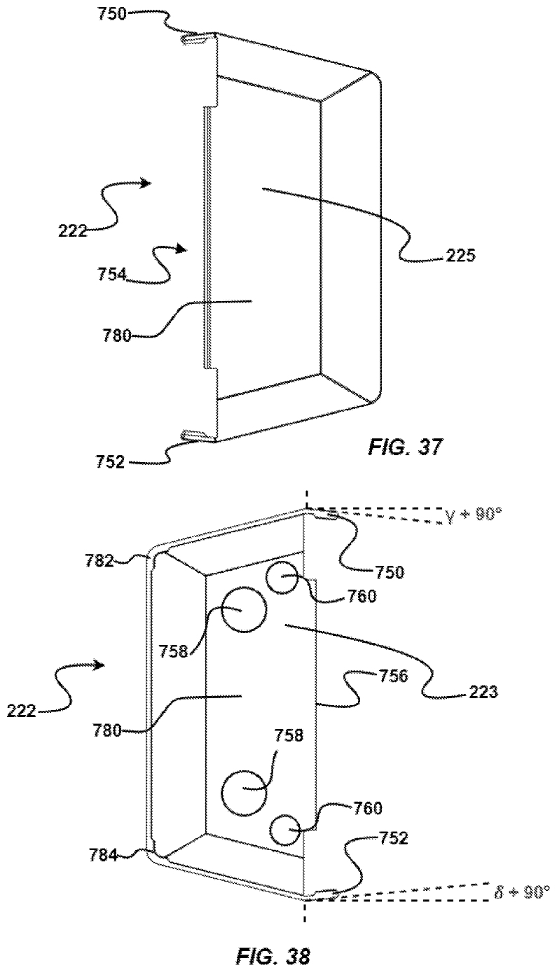

As shown in FIGS. 33 to 36, the first front cover 122 includes a shallow cutaway midsection 732 to accommodate the central knuckle and the rotation thereof during hinged movement. As also shown in FIGS. 37 to 40, the second front cover 222 includes a shallow tongued midsection 756 which extends partially under a rear portion of the central knuckle. The design of the midsections 710, 754 of the first and second covers aid in reducing ingress of moisture, dust or the like into the hinge.

Each lip includes a pair of corner sections having a lip ridge 716, 718 782, 784 extending therefrom which engage a rear surface of the front hinge member. The lip ridges 716, 718 782, 784 further aid with positive engagement of the covers with the respective leaf structure.

An inner surface of the first hinge cover includes recesses 720, 722 to accommodate a portion of the bolt heads protruding from the first leaf structure 122. Similarly, an inner surface of the second hinge cover includes recesses 758, 760 to accommodate a portion of the bolt heads protruding from the second leaf structure 222.

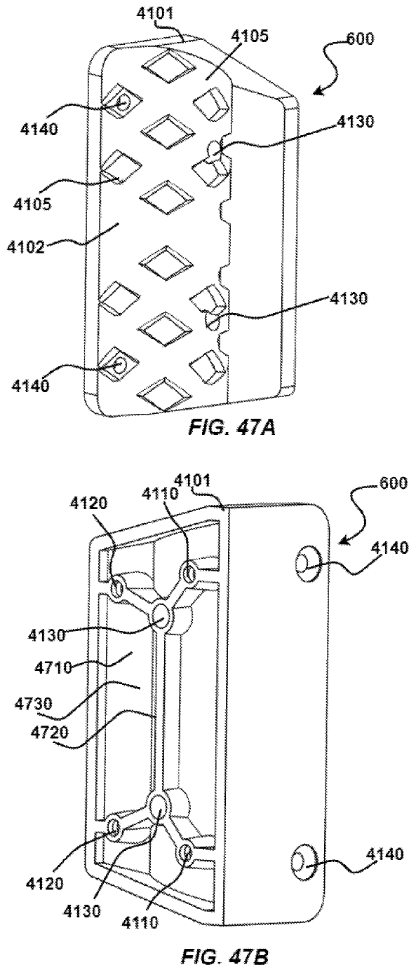

Referring to FIGS. 47A to 49B, there are shown further examples of an adaptor 600 for a hinge, such as hinge 1 discussed above. In particular, the adaptor 600 is configured to connect the hinge 1 to a post 4410, such as a pole coupled to a chain wire fence (not shown). It will be appreciated that the adaptor is universally configured and may be used for attaching the hinge 1 to a post which supports a gate or the like (i.e., does not support a chain wire fence).

The adaptor 600 includes a body 4101 having a coupling surface 4710 including a first and second pair of coupling holes 4110, 4120 for coupling the hinge 1 to the adaptor 600 via a first and second pair of fasteners respectively 105a, 105b, 107a, 107b. The adaptor 600 further includes a mounting surface 4102 having a plurality of mounting protrusions 4105 locatable, in a mounted position, between one or more wires 4420 wrapped about the post 4410, and one or pairs of mounting holes 4130, 4140 for mounting the adaptor 600 to the post 4410. At least a third pair of fasteners 109a, 109b mount the hinge 1 and adapter 600 to the post 4410 via at least one of the one or more pairs of mounting holes 4130, 4140.

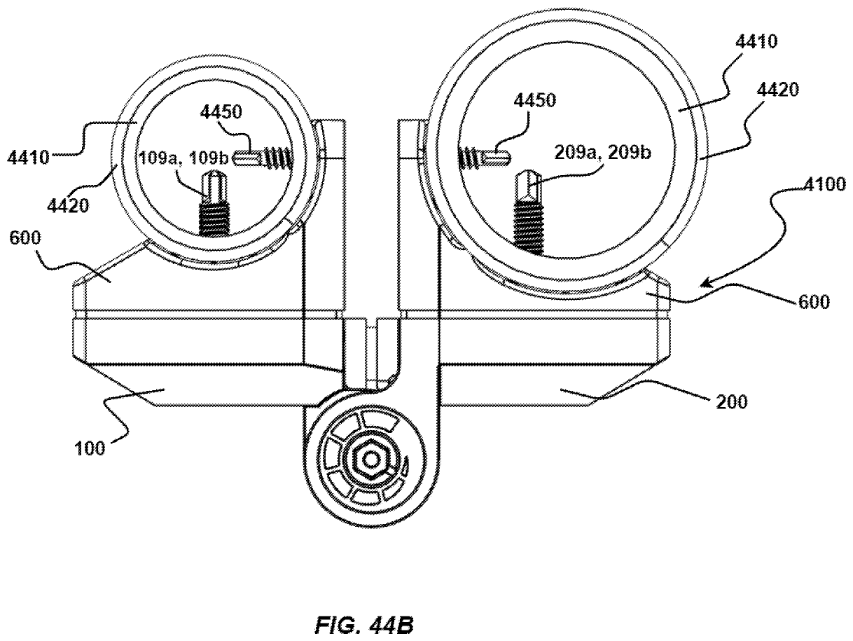

As shown in FIGS. 44A to 46B, the post 4410 is a pole having a curved outer profile providing a substantially circular cross-section. The mounting surface 4102 of the adaptor 600 has a substantially curved profile corresponding to the covered segment of the curved profile of the post 4410. As can be seen in the relevant figures, the adaptor 600 surrounds approximately a one quarter segment to a one third segment of the perimeter of the post 4410. Advantageously, channels defined between neighbouring mounting protrusions 4105 accommodate the one or more wires 4420 wrapped about the post 4410, such that the plurality of mounting protrusions 4105 can sit substantially flush against the post 4410 to create a secure attachment between the hinge 1 and the post 4410.

Preferably, each mounting protrusion 4105 has a mounting face having a curved profile that corresponds to a further segment of the curved profile of the post 4410 such that each mounting face sits substantially flush against the post. It will be apparent that the further segment is smaller than the segment of the post 4410 which the adaptor 600 covers. A majority of the mounting protrusions 4105 have a cross-sectional profile substantially corresponding to an equilateral quadrilateral, such as a rhombus to thereby correspond to helical windings of wire about the post for certain mounting scenarios.

As shown in FIG. 44A, the one or more wires 4420 can be wrapped about the post 4410 in a helical manner. The helically wrapped wire may be securing a chain wire fence to the post. A portion of the one or more wires covered by the adaptor 600 in the mounting position are located between neighbouring mounting protrusions of the adaptor to allow the mounting faces of the mounting protrusions to sit substantially flush against the post. The wire is located with a channel extending helically along the mounting surface 4102 between diagonally adjacent protrusions 4105.

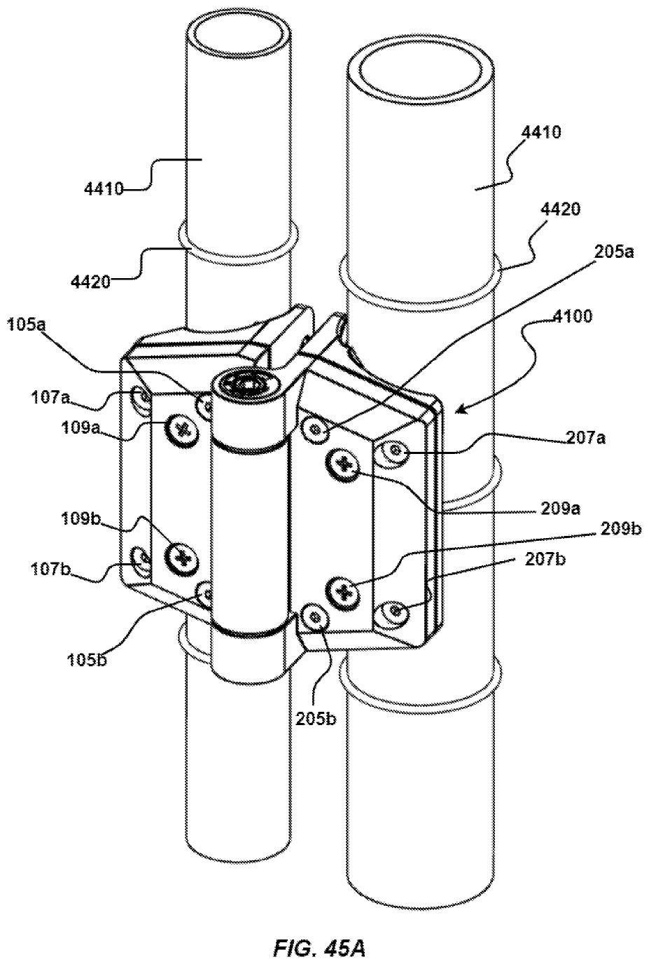

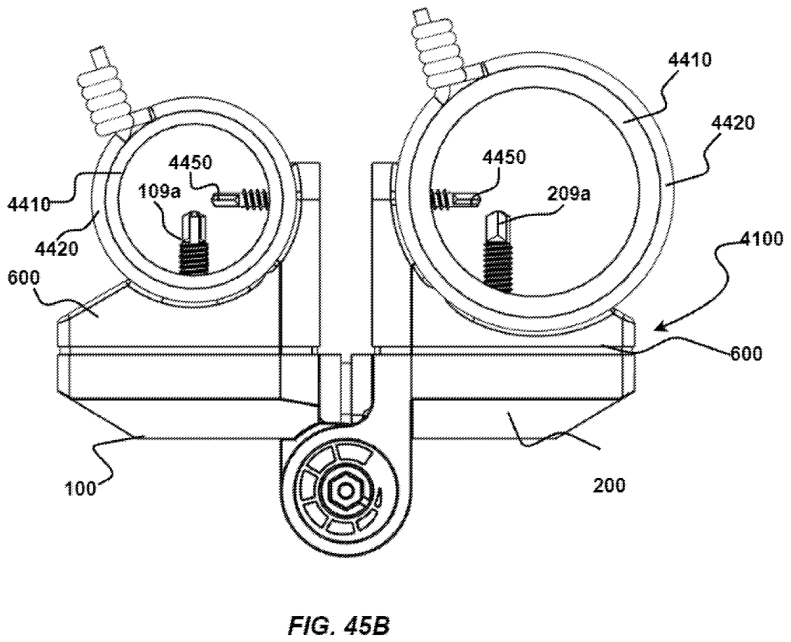

In another example as shown in FIG. 45A, the one or more wires can be a plurality of tie-wires which are tied around the post to thereby secure a chain link fence to the post. A portion of one of the tie-wires that are covered by the adaptor 600 is located within a clearance located between an upper portion of the mounting protrusions 4105 and a lower portion of the mounting protrusions 4105 of the adaptor 600 to allow the mounting faces of the mounting protrusions 4105 to sit substantially flush against the post.

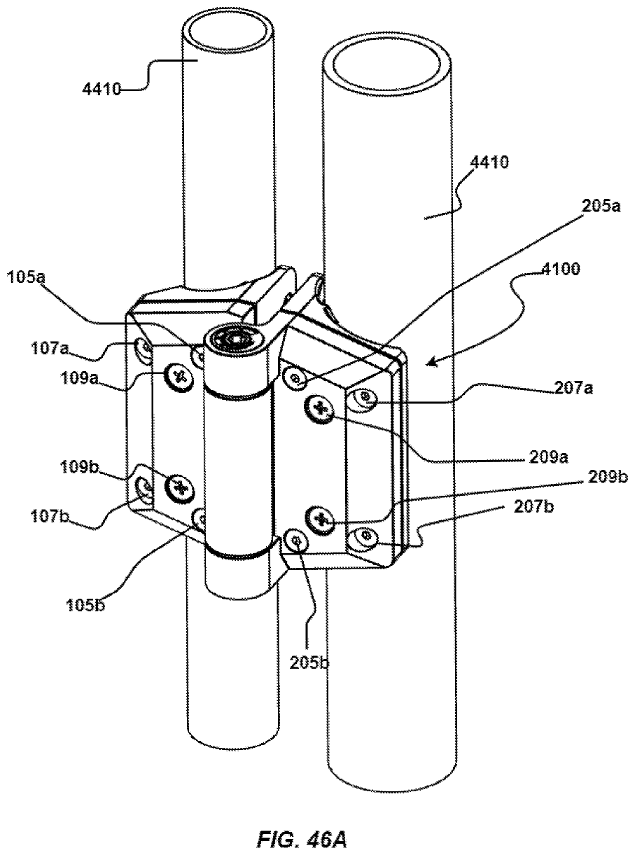

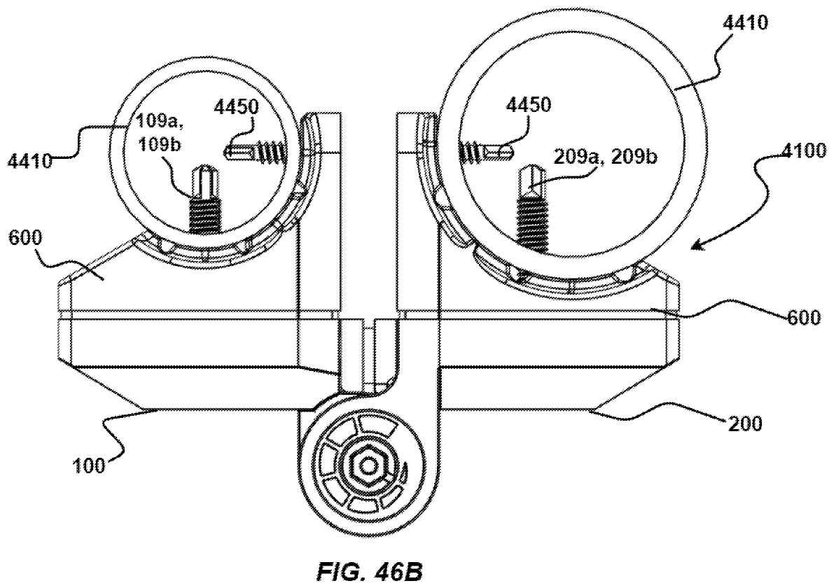

As shown in FIG. 46A, the adaptor 600 can be used to attach the hinge 1 to the post without wire being wrapped about the post. Therefore, as shown in FIGS. 44A to 46A, the adaptor 600 is a universal adaptor which can accommodate various mounting situations for the hinge 1. The chain wire fence supported by the post 4410 can comprise of a diamond wire mesh. Some of the diamond wire mesh can be located within channels defined between neighbouring mounting protrusions in the mounted position.

As shown in FIGS. 47A to 49B, the body of the adaptor 600 includes the one or more mounting holes which includes a pair of mounting holes 4130 and a further pair of mounting holes 4140 both extending from the coupling surface 4710 through to the mounting surface 4102. The further pair of mounting holes 4140 extend substantially orthogonally to the pair of mounting holes, such that the respective fasteners extend orthogonally within the post as shown in FIGS. 44B, 45B, and 46B. The third pair of fasteners 109a, 109b fasten the hinge 1, coupled to the adaptor 600, via the pair of mounting holes 4130. A fourth pair of fasteners 4450 fasten the hinge 1 coupled to the adaptor 600 to the post 4410 via the further pair of mounting holes 4140. As shown in FIGS. 47A, 48A and 49A, the further pair of mounting holes 4140 protrude through respective mounting protrusions 4105.

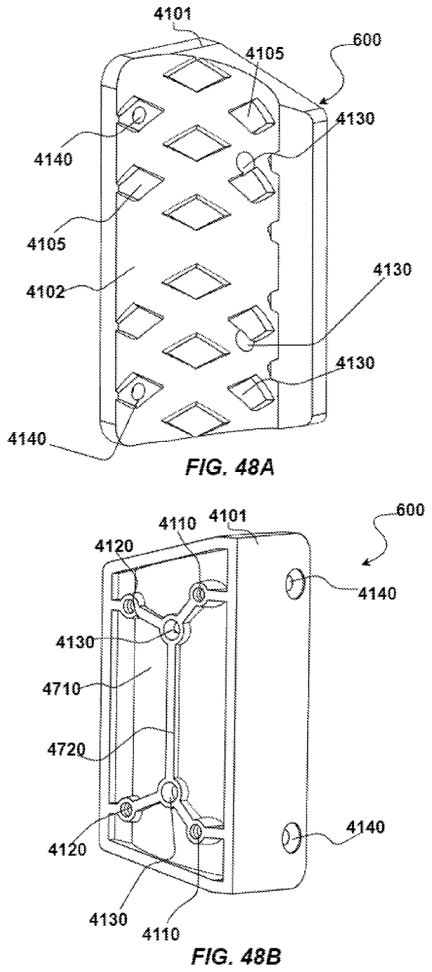

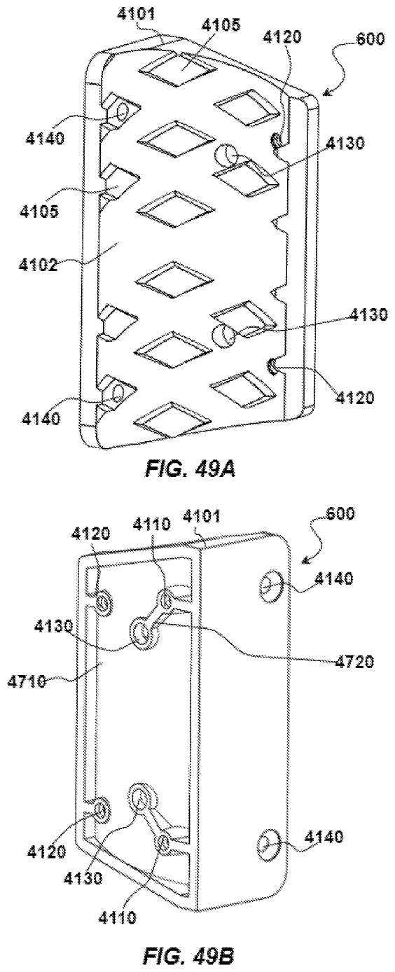

As discussed above, the adaptor is coupled to the hinge via the coupling surface 4710, wherein the coupling surface include the first and second pair of coupling holes 4110, 4120. The first and second coupling holes 4110, 4120 are threaded holes which can receive the first and second pair of fasteners 105, 105 which are threaded fasteners. As shown in FIG. 47A and FIG. 47B as well as FIG. 48A and FIG. 48B, the threaded holes 4110, 4120 are blind holes. However, the example of the adaptor shown in FIGS. 49A and 49B, the second pair of coupling holes are not provided as blind holes and therefore extend through the body when accommodating larger pipes. As shown in FIGS. 47B, 48B and 49B, the coupling surface may include a cavity to reduce the amount of material of the body. Webbing 4720 may extend between walls defining the various coupling and mounting holes to provide strength to the adaptor. The adaptor is preferably made of a cast metal, such as steel.

Various sized adaptors 600 can be provided for differently sized posts. For example, the adaptor 600 of FIGS. 47A and 47B is configured to attach to 25 Nominal Bore pipe. Furthermore, the adaptor 600 shown in FIGS. 48A and 48B is configured to attach to a 32 Nominal Bore pipe. Additionally, the adaptor 600 shown in FIGS. 49A and 49B is configured to attach to a 40 Nominal Bore pipe.

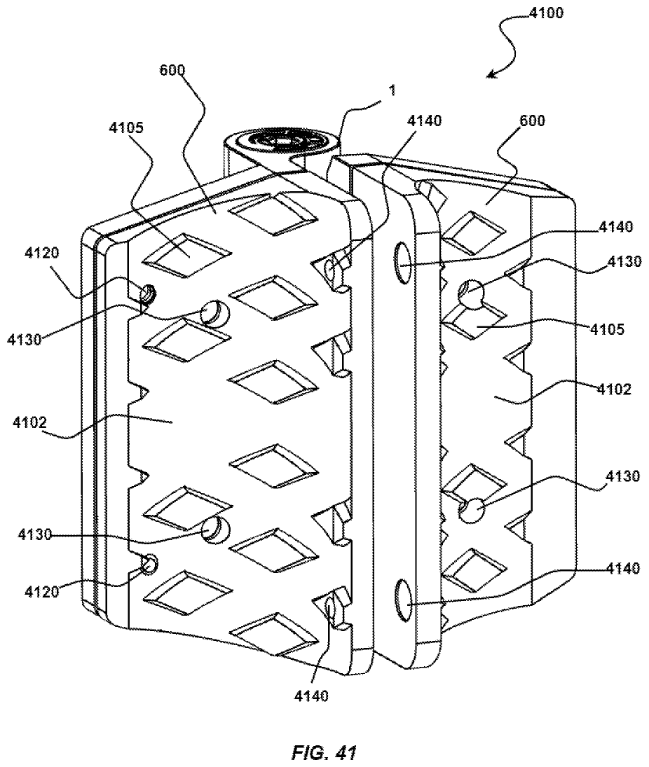

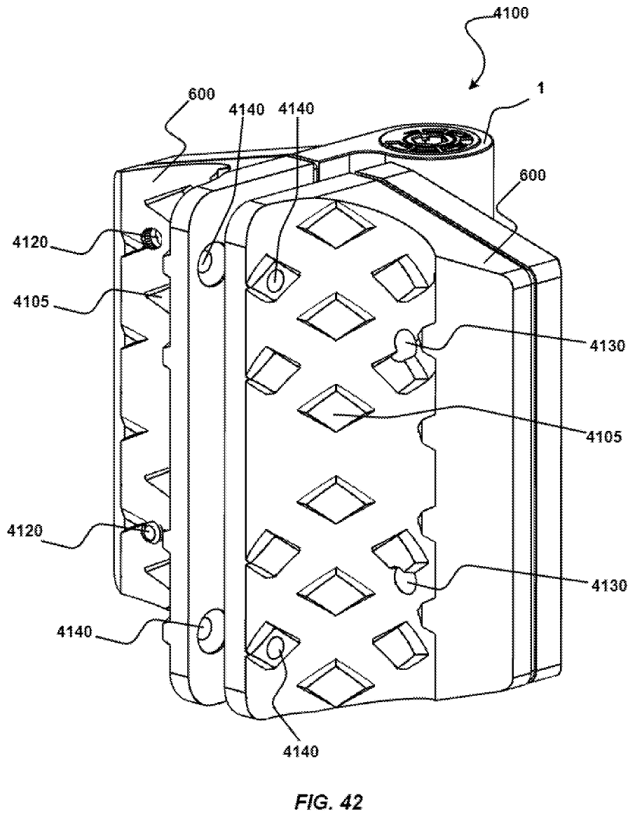

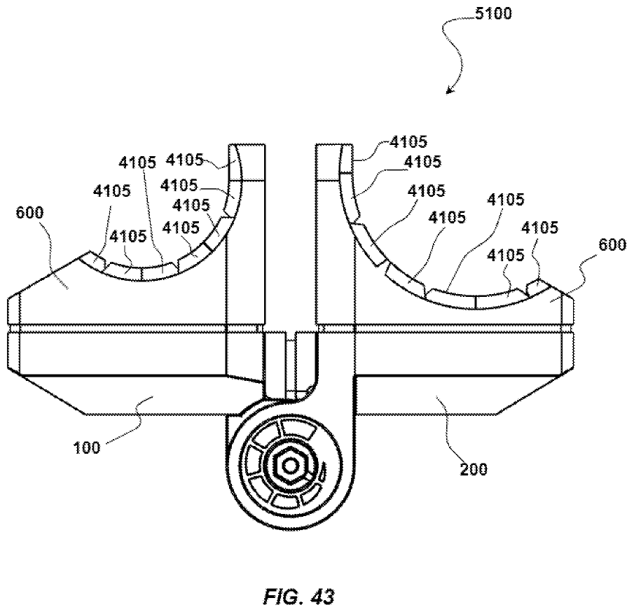

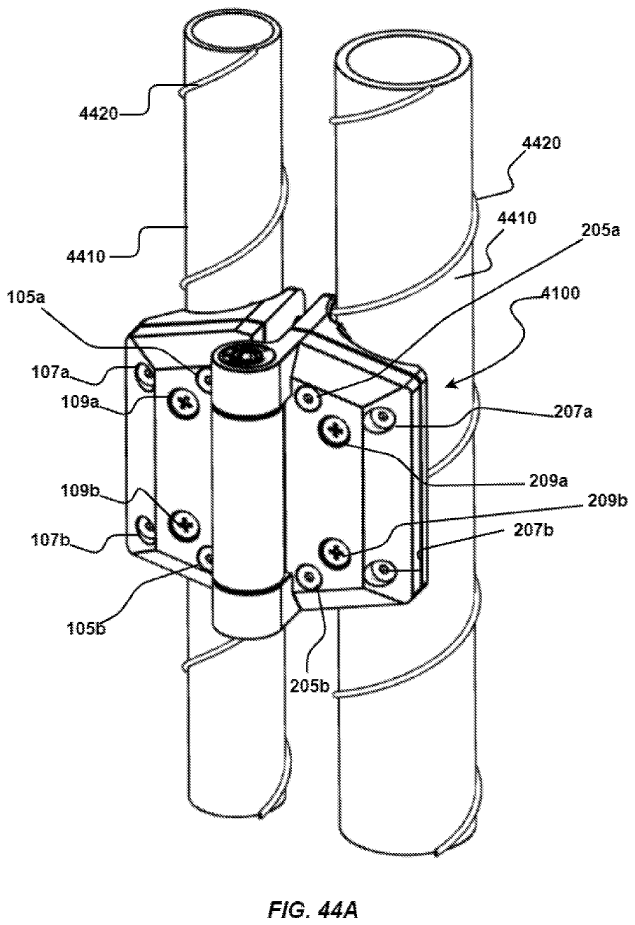

FIGS. 41 to 46B show various schematic views of a hinge assembly wherein a first adaptor 600 is coupled to the first leaf assembly 100 of the hinge 1 and a second adaptor 600 is coupled to the second leaf assembly of the hinge 1. In these examples, the first and second adaptor 600 are differently sized adaptor to attach the hinge to differently sized posts. It will be appreciated that this is merely provided as an example and that it is possible for two adaptors of the same size to be coupled to the hinge, or for a single adaptor to be coupled to a single leaf assembly. It will also be appreciated that the hinge assembly can have one or more covers attached as discussed above.

With reference to FIGS. 50-52, disclosed is an alternative embodiment of the torsion adjustment structure 408 that can be used with any of the hinges 1 described herein and is adapted to restrict increasing the potential energy stored by the spring 401 to within predetermined limits.

The neck portion 418 is configured with a groove 425. The groove 425 is formed tangentially of the hinge axis 10 in the outer surface of the neck portion 418. The groove 425 is formed circumferentially into the neck portion 418, and configured to span partially about the circumference of the neck portion 418. In the embodiment shown, the groove spans 270° about the circumference of the neck portion 418, though other values may be selected.

A projection 427 is adapted to locate within the groove 425. In the depicted embodiment of FIGS. 50-52, the projection 427 is fixed in relation to the barrel cap 411 within the void 416 of which the torsion adjustment structure 408 locates. As depicted, the hole 412a of the top barrel cap 411a is a through hole, such that the distal tip of the upper grub screw 414a forms the projection 427. By this arrangement, as a rotational force is applied to the torsion adjustment structure 408 as hereinbefore described, the projection 427 will travel within the groove 425 about the hinge axis 10. As the groove 425 spans only partially about the circumference of the neck portion 418, rotational movement between the torsion adjustment structure 408 and the barrel cap 411a is restricted due to abutment of the projection 427 with the end walls 426 of the groove 425 which thereby limits the extent of torsion that can be applied to the spring. Therefore, by preconfiguring the circumferential extent of the groove relative the hinge axis, the amount of torsion that can be applied to the spring 401 of the bias structure 400 can be limited. For example, the circumferential extent of the groove 425 may be selected to limit the possible torsion applied to the spring 401 to safe limits to prevent failure of the spring or otherwise reduced functionality of the hinge 1.

It will be appreciated that the one or more dampeners could come into contact with one or more intermediary linkage members, and/or be connected with one or more intermediary linkage members during movement to the closed position to enable the dampener to be actuated by indirect contact with the opposing hinge assembly via the one or more linkage members. This arrangement thereby allows the one or more dampeners to be orientated in various orientations, other than orthogonally, relative to the hinge axis. For example, the longitudinal axis of the dampener could be orientated parallel to the hinge axis and a first linkage structure, such as a wedge structure connected to the dampener, could come into contact with an opposing wedge structure provided by the opposing hinge assembly when moving toward the closed position. The two wedge structures cooperate together during movement toward the closed position to redirect and transfer the force applied by the opposing hinge to the dampener in the direction parallel with the hinge axis, such that the dampener retracts in a direction parallel with the hinge axis to thereby dampen movement of the hinge toward the closed position.

Many modifications will be apparent to those skilled in the art without departing from the scope of the present invention.

### PARTS LIST

1 hinge
10 hinge axis
1000 panel
1001 first panel
1002 second panel
1003 exterior frame of gate
100 first leaf assembly
101 first leaf structure
102 edge periphery/sidewalls
102a inner edge periphery
102b outer edge periphery
102c upper edge periphery
102d lower edge periphery
103 corner periphery
103a corner periphery included between inner and upper edge peripheries
103b corner periphery included between inner and lower edge peripheries
103c corner periphery included between outer and upper edge peripheries
103d corner periphery included between outer and lower edge peripheries
104 first pair of holes
104a one hole of the first pair of holes
104b other hole of the first pair of holes
105 first pair of fasteners
105a one fastener of the first pair of fasteners
105b other fastener of the first pair of fasteners
106 second pair of holes
106a one hole of the second pair of holes
106b other hole of the second pair of holes
107 second pair of fasteners
107a one fastener of the second pair of fasteners
107b other fastener of the second pair of fasteners
108 third pair of holes
108a one hole of the third pair of holes
108b other hole of the third pair of holes
109 third pair of fasteners
109a one fastener of the third pair of fasteners
109b other fastener of the third pair of fasteners
110 knuckle
111 outer face of first hinge component
112 interior space
112a upper subspace of interior space
112b mid subspace of interior space
112c lower subspace of interior space
113 stiffening walls
114 gap in inner sidewall
115 bosses
116 screw tube/threaded stem
117 rear cover
118 inner surface of rear cover
119 stiffening walls
120 interior space
121 cavity for dampener housing
122 front cover
123 inner surface of front cover
124 clips
125 outer surface of front cover
126 aperture in knuckle
200 second leaf assembly
201 second leaf structure
202 edge periphery/side walls
202a inner edge periphery
202b outer edge periphery
202c upper edge periphery
202d lower edge periphery
203 corner periphery
203a corner periphery included between inner and upper edge peripheries
203b corner periphery included between inner and lower edge peripheries
203c corner periphery included between outer and upper edge peripheries
203d corner periphery included between outer and lower edge peripheries
204 first pair of holes
204a one hole of the first pair of holes
204b other hole of the first pair of holes
205 first pair of fasteners
205a one fastener of the first pair of fasteners
205b other fastener of the first pair of fasteners
206 second pair of holes
206a one hole of the second pair of holes
206b other hole of the second pair of holes
207 second pair of fasteners
207a one fastener of the second pair of fasteners
207b other fastener of the second pair of fasteners
208 third pair of holes
208a one hole of the third pair of holes
208b other hole of the third pair of holes
209 third pair of fasteners
209a one fastener of the third pair of fasteners
209b other fastener of the third pair of fasteners
210 knuckles
210a upper knuckle
210b lower knuckle
211 outer face of second hinge component
212 interior space
212a upper subspace of interior space
212b mid subspace of interior space
212c lower subspace of interior space
213 stiffening walls
214 gap
215 bosses
216 screw tube/threaded stem
217 rear cover
218 inner surface of rear cover
219 stiffening walls
220 interior space
221 cavity for dampener housing
222 front cover
223 inner surface of front cover
224 clips
225 outer surface of front cover
226 hole in knuckle
226a hole in top knuckle
226b hole in bottom knuckle
400 bias structure
401 spring
402 coils
403 first end of spring
404 diametrically extending tail of spring
405 barrel
406 first cavity
407 second cavity
408 torsion adjustment structure
409 pair of protrusions
409a one protrusion of the pair of protrusions
409b other protrusion of the pair of protrusions
410 barrel
411 barrel cap
411a top barrel cap
411b bottom barrel cap
412 hole in barrel cap
412a hole in upper barrel cap
412b hole in bottom barrel cap
413 outer neck
413a outer neck of top barrel cap
413b outer neck of bottom barrel cap
414 grub screw
414a upper grub screw
414b lower grub screw
415 inner neck
415a inner neck of top barrel cap
415b inner neck of bottom barrel cap
416 void
417 shoulder of torsion adjustment structure
418 neck portion of torsion adjustment structure
419 indicia
420 first engaging surface
421 second engaging surface
422 pair of protrusions
422a first protrusion of the pair
422b second protrusion of the pair
423 further diametrically extending tail
424 tool hole
425 groove in neck portion of torsion adjustment structure
426 end walls of groove
427 projection
500 dampener assembly
501 dampener
501a upper dampener
501b lower dampener
502 Dampener housing
503 cavity
503a upper cavity
503b lower cavity
504 striking component
505 scallops/recess
506 aperture for screw tube
507 screw for screw tube)
508 striking surface
509 indents
510 cover member
511 outer surface of cover member
512 side walls of cover member
600 adaptor
601 channel
602 screw block
603 inner side wall
604 aperture in inner side wall
605 strengthening ribs
606 outer side wall
607 rear side wall
608 screw block apertures
609 webbed walls
702 main body of first cover
704 lip of first cover
710 mouth of first cover
712 first clip of first cover
714 second clip of first cover
716 first lip ridge of first cover
718 second lip ridge of first cover
720 first bolt head recess of first cover
722 second bolt head recess of first cover
724 lower first clip ridge of first cover
726 lower second clip ridge of first cover
728 upper second clip ridge of first cover
730 upper first clip ridge of first cover
732 recessed midsection of first cover
750 first clip of second cover
752 second clip of second cover
754 mouth of second cover
758 first bolt head recess of second cover
760 second bolt head recess of second cover
780 main body of second cover
782 upper lip ridge of second cover
784 lower lip ridge of second cover
786 lip of second cover
792 lower first clip ridge of second cover
794 lower second clip ridge of second cover
796 upper second clip ridge of second cover
798 upper first clip ridge of second cover
4101 body
4102 mounting surface
4105 mounting protrusion
4110 first coupling hole
4120 second coupling hole
4130 first mounting hole
4140 second mounting hole
4410 pole
4420 wire
4710 coupling surface

1. A hinge comprising:
a first leaf assembly hingedly coupled to a second leaf assembly about a hinge axis for movement between an open position and a closed position;
the first leaf assembly including a leaf structure having:
a first pair of holes for receiving a first pair of fasteners configured to attach the leaf structure to at least one of one or more structures;
a second pair of holes for receiving a second pair of fasteners configured to attach the leaf structure to at least one of the one or more structures; and,
a third pair of holes for receiving a third pair of fasteners configured to attach the first structure to at least one of the one or more structures; wherein,
the third pair of holes is flanked on either side by the first pair of holes and the second pair of holes.

2. The hinge according to claim 1, wherein individual holes of the first pair of holes are aligned parallel to the hinge axis.

3. The hinge according to claim 1 or 2, wherein individual holes of the second pair of holes are aligned parallel to the hinge axis.

4. The hinge according to any one of the preceding claims, wherein individual holes of the third pair of holes are aligned parallel to the hinge axis.

5. The hinge according to any one of the preceding claims, wherein individual holes of the third pair of holes are more closely spaced than individual holes of the first pair of holes.

6. The hinge according to any one of the preceding claims, wherein individual holes of the third pair of holes are more closely spaced than individual holes of the second pair of holes.

7. The hinge according to any one of the preceding claims, wherein each individual hole of the first pair of holes locates closer to at least one edge periphery of the leaf structure than at least one individual hole of the third pair of holes.

8. The hinge according to any one of the preceding claims, wherein each individual hole of the first pair of holes locates closer to two edge peripheries of the leaf structure than at least one individual hole of the third pair of holes.

9. The hinge according to any one of the preceding claims, wherein each individual hole of the first pair of holes locates closer to their most proximal corner periphery than either individual hole of the third pair of holes.

10. The hinge according to any one of the preceding claims, wherein each individual hole of the second pair of holes locates closer to at least one edge periphery of the leaf structure than at least one individual hole of the third pair of holes.

11. The hinge according to any one of the preceding claims, wherein each individual hole of the second pair of holes locates closer to two edge peripheries of the leaf structure than at least one individual hole of the third pair of holes.

12. The hinge according to any one of the preceding claims, wherein each individual hole of the second pair of holes locates closer to their most proximal corner periphery than either individual hole of the third pair of holes.

13. The hinge according to any one of the preceding claims, wherein one or both holes of the first pair of holes are sized to provide clearance at least partially about a fastener of the first pair of fasteners received by said one or both holes.

14. The hinge according to any one of the preceding claims, wherein one or both holes of the second pair of holes are sized to provide clearance at least partially about a fastener of the second pair of fasteners received by said one or both holes.

15. The hinge according to any one of the preceding claims, wherein one or both holes of the third pair of holes are sized to provide clearance at least partially about a fastener of the third pair of fasteners received by said one or both holes.

16. The hinge according to any one of the preceding claims, wherein one or both of the third pair of holes are adapted to receive a fastener of the third pair of fasteners configured for load-bearing duty independent of the second pair of fasteners.

17. The hinge according to any one of the preceding claims, wherein one or both of the third pair of holes are adapted to receive a fastener of the third pair of fasteners configured for load-bearing duty independent of the second pair of fasteners.

18. The hinge according to any one of the preceding claims, wherein one or both of the third pair of holes is adapted to receive a fastener of the third pair of fasteners configured as larger than one or both of the first pair of fasteners.

19. The hinge according to any one of the preceding claims, wherein one or both of the third pair of holes is adapted to receive a fastener of the third pair of fasteners configured as larger than one or both of the second pair of fasteners.

20. The hinge according to any one of the preceding claims, wherein one or both of the third pair of holes are larger than one or both of the first pair of holes.

21. The hinge according to any one of the preceding claims, wherein one or both of the third pair of holes are larger than one or both of the second pair of holes.

22. The hinge according to any one of claims 1 to 21, wherein the second leaf assembly includes a mounting structure to mount the second leaf assembly to a mounting structure separate to the hinge.

23. The hinge according to any one of the preceding claims, further including a spring coupled to the first and second leaf assemblies to bias the first and second leaf assemblies to move from an open position to a closed position.

24. The hinge according to claim 23, wherein the first and second leaf assemblies include a plurality of knuckles defining a barrel housing the spring, wherein a longitudinal axis of the spring being coaxial with the hinge axis, wherein the hinge further includes:
a barrel cap having an inner and outer neck, wherein the outer neck has a first engaging surface, the barrel cap being received within one end of the barrel; and
a torsion adjustment structure located within a void defined by the inner neck, the torsion adjustment being coupled to a first end of the spring, the torsion adjustment structure having a second engaging surface which engages with the first engaging surface to restrict rotational movement of the torsion adjustment structure relative to the barrel cap whilst under bias of the spring;
wherein a sufficient rotational force applied to the torsion adjustment structure causes the rotational movement of the torsion adjustment structure relative to the barrel cap to increase potential energy stored by the spring.

25. The hinge of claim 24, wherein the first and second engaging surfaces have corresponding sawtooth profiles.

26. The hinge of claim 24 or 25, wherein the spring includes a diametrically extending tail defining a first and second cavity with at least some of the coils of the spring, wherein the torsion adjustment structure includes a pair of protrusions which are received within the respective first and second cavities to enable rotational force applied to the torsion adjustment structure to be transferred to the spring to adjust the potential energy stored by the spring.

27. The hinge according to claim 26, wherein the spring includes a further diametrically extending tail receivable within an aperture located in a wall of the leaf structure, the wall having protrusions extending therefrom which are receivable within cavities defined by at least some of the coils of the spring and the further diametrically extending tail to couple the spring to the first leaf structure.

28. The hinge according to any one of claims 1 to 27, further including a dampener to act against movement of the first and second hinge into the closed position.

29. The hinge according to claim 28, wherein the dampener has a longitudinal axis which is offset from hinge axis.

30. The hinge of claim 29, wherein the longitudinal axis of the dampener does not intersect with the hinge axis during any part of the movement between the open and closed positions.

31. The hinge according to claim 29 or 30, wherein the longitudinal axis is located between the hinge axis and a mounting face of the first leaf assembly configured to bear against at least one of the one or more structures to which the first leaf assembly attaches.

32. The hinge according to any one of claims 28 to 31, further including a plurality of dampeners located within a dampener housing mounted to the first leaf assembly with ends of said plurality of dampeners projecting from the housing when the hinge is in the open position, such that as the hinge is moved into the closed position, the projecting dampener ends interact with a striking surface associated with the second leaf assembly.

33. The hinge according to claim 32, further including a cover member covering the protruding ends of the dampeners, the cover member configured for co-movement with the dampeners.

34. The hinge according to claim 33, wherein the cover member is limited to linear reciprocal movement along the dampener longitudinal axis relative the dampener housing.

35. The hinge according to any one of the preceding claims, wherein the second leaf assembly includes a further leaf structure having:
a first pair of holes for receiving a first pair of fasteners configured to attach the further leaf structure to at least one of one or more further structures;
a second pair of holes for receiving a second pair of fasteners configured to attach the further leaf structure to at least one of the one or more further structures; and
a third pair of holes for receiving a third pair of fasteners configured to attach the further leaf structure to at least one of the one or more further structures; wherein,
the third pair of holes is flanked on either side by the first pair of holes and the second pair of holes.

36. The hinge according to claim 35, wherein the first pair of holes, the second pair of holes and the third pair of holes of the further leaf structure have equivalent properties to the first pair of holes, the second pair of holes and the third pair of hole of the leaf structure according to any one of claims 2 to 22.

37. A hinge comprising:
a first leaf assembly hingedly coupled to a second leaf assembly about a hinge axis for movement between an open position and a closed position, wherein a bias structure biases movement into the closed position, and a dampening assembly configured to slow movement into the closed position, the dampening assembly including a dampener housing and a cover member cooperating to contain one or more dampeners, the cover member configured for reciprocal movement relative the housing thereby transferring a reciprocal force to the one or more dampeners.

38. The hinge of claim 37, wherein the hinge axis is offset from a dampener axis.

39. The hinge of claim 38, wherein the dampener axis does not intersect with the hinge axis during any part of the movement between the open and closed positions.

40. The hinge of claim 39, further comprising a striking structure locating on an opposite leaf assembly to the dampener housing, a striking surface of the striking structure contacting with the cover member during movement of the hinge into the closed position.

41. An adapter for mounting the hinge according to any one of claims 1-36, the adaptor having a channel portion for receiving a frame member of a frame structure, and a screw block adapted to receive at least one of the first, second and/or third pairs of fasteners.

42. An adaptor for connecting a hinge to a frame, the adaptor including a channel for receiving the frame, and a screw block configured to provide an extension surface providing an additional site for connection with the hinge.

43. A cover for a leaf structure of a hinge, the cover including:
a main cover body having a lip extending partially about a periphery thereof, the lip defining a mouth for receiving the leaf structure of the hinge; and
a first clip and second clip projecting outwardly from opposing sides of the mouth, the first and second clip being resilient and inwardly angled toward each other to resiliently engage the leaf structure when received within the mouth.

44. The cover of claim 43, wherein the first and second clip are inwardly angled by an angular offset relative to a hinge axis of the hinge, wherein the angular offset is between approximately 92° and 100° relative to the hinge axis.

45. The cover of claim 44, wherein the angular offset is between approximately 93° and 97° relative to the hinge axis.

46. The cover of claim 45, wherein the angular offset is between approximately 95° and 96° relative to the hinge axis.

47. The cover of any one of claims 43 to 46, wherein the first clip and second clip include a first and second ridge, wherein the first and second ridges extend orthogonally to each other along a periphery of the respective clip, wherein each ridge resiliently engages over an edge of the leaf structure.

48. The cover of any one of claims 43 to 47, wherein the cover is made of plastic.

49. The cover of any one of claims 43 to 47, wherein the cover is made of metal.

50. The cover of claim 49, wherein the metal is stainless steel.

51. The cover of any one of claims 43 to 50, wherein the mouth includes a recessed midsection to accommodate a portion of a barrel of the hinge.

52. The cover of any one of claims 43 to 50, wherein the mouth includes a tongued midsection to protrude between a barrel of the hinge and the leaf structure.

53. The cover of any one of claims 43 to 52, wherein the cover is configured to cover at least the leaf structure of the hinge configured according to any one of claims 1 to 40.

54. An adaptor for connecting a hinge to a post coupled to a chain wire fence, wherein the adaptor includes a body having a coupling surface including a first pair of coupling holes for coupling the hinge to the adaptor via a first and second pair of fasteners; and a mounting surface having a plurality of mounting protrusions locatable, in a mounted position, between one or more wires wrapped about the post, and one or more pairs of mounting holes for mounting the adaptor to the post, wherein a third pair of fasteners mount the hinge and adapter to the post via the one or more pairs of mounting holes.

55. The adaptor of claim 54, wherein the post has a curved profile, wherein the mounting surface has a substantially curved profile corresponding to a segment of the curved profile of the post.

56. The adaptor of claim 55, wherein each mounting protrusion has a mounting face having a curved profile that corresponds to a further segment of the curved profile of the post such that each mounting face sits substantially flush against the post, wherein the further segment is smaller than the segment.

57. The adaptor of claim 56, wherein a majority of the mounting protrusions have a cross-sectional profile of an equilateral quadrilateral.

58. The adaptor of claim 57, wherein the equilateral quadrilateral is a rhombus.

59. The adaptor of any one of claims 54 to 58, wherein the one or more wires are helically wrapped about the post, wherein a portion of the one or more wires covered by the adaptor in the mounting position are located between neighbouring mounting protrusions of the adaptor to allow the mounting faces of the mounting protrusions to sit substantially flush against the post.

60. The adaptor of any one of claims 54 to 58, wherein the one or more wires are a plurality of tie-wires tied around the post, wherein a portion of one of the tie-wires that is covered by the adaptor is located within a clearance between an upper portion of the mounting protrusions and a lower portion of the mounting protrusions of the adaptor to allow the mounting faces of the mounting protrusions to sit substantially flush against the post.

61. The adaptor of any one of claims 54 to 60, wherein the one or more pairs of mounting holes include a first pair of mounting holes and a second pair of mounting holes, the first and second mounting extending from the coupling surface through to the mounting surface, wherein the second pair of mounting holes extend orthogonally to the first pair of mounting holes, wherein the first pair of mounting holes are configured to receive the third pair of fasteners to fasten the hinge coupled to the adaptor to the post, wherein the second pair of mounting holes are configured to receive a fourth pair of fasteners to fasten the hinge coupled to the adaptor to the post.

62. The adaptor of claim 61, wherein the further pair of mounting holes protrude through at least some of the plurality of mounting protrusions.

63. The adaptor of any one of claims 54 to 62, wherein the first and second pair of coupling holes are threaded holes.

64. The adaptor of claim 63, wherein at least one of the first and second pair of coupling holes are blind threaded holes.

65. The adaptor of any one of claims 54 to 64, wherein the post is a steel pipe, wherein the adaptor is configured to mount to the steel pipe having a pipe size of: 25 Nominal Bore, 32 Nominal Bore, or 40 Nominal Bore.

66. The adaptor of any one of claims 54 to 65, wherein the chain wire fence comprises of a diamond wire mesh, wherein some of the diamond wire mesh is located within channels defined between neighbouring mounting protrusions in the mounted position.

67. A hinge assembly comprising:
a hinge configured according to any one of claims 1 to 36; and
a cover configured according to any one of claims 43 to 53, wherein the cover is engaged with the leaf structure of the hinge.

68. A hinge assembly comprising:
a hinge configured according to claim 35 or 36;
a cover configured according to any one of claims 43 to 53, wherein the cover is engaged with the leaf structure of the hinge; and
a further cover configured according to any one of claims 43 to 53, wherein the cover is engaged with the further leaf structure of the hinge.

69. A hinge assembly comprising:
a hinge configured according to any one of claims 1 to 36;
an adaptor configured according to claim 42, wherein the hinge is connected to the adaptor.

70. A hinge assembly comprising:
a hinge configured according to any one of claims 1 to 36; and
an adaptor configured according to any one of claims 54 to 66, wherein the adaptor is coupled to the hinge.

71. The hinge assembly according to claim 70, wherein the hinge assembly further includes a cover configured according to any one of claims 43 to 53, wherein the cover is engaged with the leaf structure of the hinge.

72. A hinge assembly comprising:
a hinge configured according to claim 35 or 36;
an adaptor configured according to any one of claims 54 to 66, wherein the adaptor is coupled to the hinge;
a cover configured according to any one of claims 43 to 53, wherein the cover is engaged with the leaf structure of the hinge; and
a further cover configured according to any one of claims 43 to 53, wherein the further cover is engaged with the further leaf structure of the hinge.
